SEQUENCE LISTING (113 sequences)

SEQ ID NO: 1 - protein, 8 aa, Artificial
  GIP(1-8)
YAEGTFIS

SEQ ID NO: 2 - protein, 9 aa, Artificial
  GIP(1-9)
YAEGTFISD

SEQ ID NO: 3 - protein, 6 aa, Artificial
  GIP(3-8)
EGTFIS

SEQ ID NO: 4 - protein, 7 aa, Artificial
  GIP(3-9)
EGTFISD

SEQ ID NO: 5 - protein, 8 aa, Artificial
  2S-GIP(1-8)
YSEGTFIS

SEQ ID NO: 6 - protein, 8 aa, Artificial
  GLP-1(7-14)
HAEGTFTS

SEQ ID NO: 7 - protein, 9 aa, Artificial
  GLP-1(7-15)
HAEGTFTSD

SEQ ID NO: 8 - protein, 6 aa, Artificial
  GLP-1(9-14)
EGTFTS

SEQ ID NO: 9 - protein, 7 aa, Artificial
  GLP-1(9-15)
EGTFTSD

SEQ ID NO: 10 - protein, 8 aa, Artificial
  8S-GLP-1(7-14)
HSEGTFTS

SEQ ID NO: 11 - protein, 8 aa, Artificial
  Glucagon(1-8)
HSQGTFTS

SEQ ID NO: 12 - protein, 9 aa, Artificial
  Glucagon(1-9)
HSQGTFTSD

SEQ ID NO: 13 - protein, 42 aa, Homo sapiens
  GIP
YAEGTFISDYSIAMDKIHQQDFVNWLLAQKGKKNDWKHNITQ

SEQ ID NO: 14 - protein, 40 aa, Homo sapiens
  GIP(3-42)
EGTFISDYSIAMDKIHQQDFVNWLLAQKGKKNDWKHNITQ

SEQ ID NO: 15 - protein, 42 aa, Artificial
  2G-GIP
YGEGTFISDYSIAMDKIHQQDFVNWLLAQKGKKNDWKHNITQ

SEQ ID NO: 16 - protein, 42 aa, Artificial
  D2A-GIP
YXEGTFISDYSIAMDKIHQQDFVNWLLAQKGKKNDWKHNITQ

SEQ ID NO: 17 - protein, 42 aa, Artificial; identical to SEQ ID NO: 16
  2Aib-GIP

SEQ ID NO: 18 - protein, 42 aa, Artificial; identical to SEQ ID NO: 16
  2PS-GIP

SEQ ID NO: 19 - protein, 42 aa, Artificial; identical to SEQ ID NO: 16
  2Sar-GIP

SEQ ID NO: 20 - protein, 42 aa, Artificial
  3P-GIP
YAPGTFISDYSIAMDKIHQQDFVNWLLAQKGKKNDWKHNITQ

SEQ ID NO: 21 - protein, 42 aa, Artificial
  3Hyp-GIP
YAXGTFISDYSIAMDKIHQQDFVNWLLAQKGKKNDWKHNITQ

SEQ ID NO: 22 - protein, 42 aa, Artificial
  3K-GIP
YAKGTFISDYSIAMDKIHQQDFVNWLLAQKGKKNDWKHNITQ

SEQ ID NO: 23 - protein, 42 aa, Artificial
  3Y-GIP
YAYGTFISDYSIAMDKIHQQDFVNWLLAQKGKKNDWKHNITQ

SEQ ID NO: 24 - protein, 42 aa, Artificial
  3F-GIP
YAFGTFISDYSIAMDKIHQQDFVNWLLAQKGKKNDWKHNITQ

SEQ ID NO: 25 - protein, 30 aa, Homo sapiens
  GLP-1(7-36)
HAEGTFTSDVSSYLEGQAAKEFIAWLVKGR

SEQ ID NO: 26 - protein, 31 aa, Homo sapiens
  GLP-1(7-37)
HAEGTFTSDVSSYLEGQAAKEFIAWLVKGRG

SEQ ID NO: 27 - protein, 28 aa, Artificial
  GLP-1(7-34)
HAEGTFTSDVSSYLEGQAAKEFIAWLVK

SEQ ID NO: 28 - protein, 29 aa, Artificial
  GLP-1(7-35)
HAEGTFTSDVSSYLEGQAAKEFIAWLVKG

SEQ ID NO: 29 - protein, 28 aa, Homo sapiens
  GLP-1(9-36)
EGTFTSDVSSYLEGQAAKEFIAWLVKGR

SEQ ID NO: 30 - protein, 29 aa, Homo sapiens
  GLP-1(9-37)
EGTFTSDVSSYLEGQAAKEFIAWLVKGRG

SEQ ID NO: 31 - protein, 31 aa, Artificial
  8S-GLP-1(7-37)
HSEGTFTSDVSSYLEGQAAKEFIAWLVKGRG

SEQ ID NO: 32 - protein, 31 aa, Artificial
  8G-GLP-1(7-37)
HGEGTFTSDVSSYLEGQAAKEFIAWLVKGRG

SEQ ID NO: 33 - protein, 31 aa, Artificial
  8V-GLP-1(7-37)
HVEGTFTSDVSSYLEGQAAKEFIAWLVKGRG

SEQ ID NO: 34 - protein, 31 aa, Artificial
  22E-GLP-1(7-37)
HAEGTFTSDVSSYLEEQAAKEFIAWLVKGRG

SEQ ID NO: 35 - protein, 31 aa, Artificial
  22K-GLP-1(7-37)
HAEGTFTSDVSSYLEKQAAKEFIAWLVKGRG

SEQ ID NO: 36 - protein, 31 aa, Artificial
  8V,22E-GLP-1(7-37)
HVEGTFTSDVSSYLEEQAAKEFIAWLVKGRG

SEQ ID NO: 37 - protein, 31 aa, Artificial
  8V,22K-GLP-1(7-37)
HVEGTFTSDVSSYLEKQAAKEFIAWLVKGRG

SEQ ID NO: 38 - protein, 31 aa, Artificial
  8G,22E-GLP-1(7-37)
HGEGTFTSDVSSYLEEQAAKEFIAWLVKGRG

SEQ ID NO: 39 - protein, 31 aa, Artificial
  8G,22K-GLP-1(7-37)
HGEGTFTSDVSSYLEKQAAKEFIAWLVKGRG

SEQ ID NO: 40 - protein, 31 aa, Artificial
  8V,30E-GLP-1(7-37)
HVEGTFTSDVSSYLEGQAAKEFIEWLVKGRG

SEQ ID NO: 41 - protein, 31 aa, Artificial
  8G,30E-GLP-1(7-37)
HGEGTFTSDVSSYLEGQAAKEFIEWLVKGRG

SEQ ID NO: 42 - protein, 31 aa, Artificial
  8V,37H-GLP-1(7-37)
HVEGTFTSDVSSYLEGQAAKEFIAWLVKGRH

SEQ ID NO: 43 - protein, 31 aa, Artificial
  8G,37H-GLP-1(7-37)
HGEGTFTSDVSSYLEGQAAKEFIAWLVKGRH

SEQ ID NO: 44 - protein, 31 aa, Artificial
  34R-GLP-1(7-37)
HAEGTFTSDVSSYLEGQAAKEFIAWLVRGRG

SEQ ID NO: 45 - protein, 31 aa, Artificial
  18K-GLP-1(7-37)
HAEGTFTSDVSKYLEGQAAKEFIAWLVKGRG

SEQ ID NO: 46 - protein, 31 aa, Artificial
  8G,22E,36G-GLP-1(7-37)
HGEGTFTSDVSSYLEEQAAKEFIAWLVKGGG

SEQ ID NO: 47 - protein, 31 aa, Artificial
  8Aib,22Aib-GLP-1(7-37)
HXEGTFTSDVSSYLEXQAAKEFIAWLVKGRG

SEQ ID NO: 48 - protein, 31 aa, Artificial
  8Aib,35Aib-GLP-1(7-37)
HXEGTFTSDVSSYLEGQAAKEFIAWLVKXRG

SEQ ID NO: 49 - protein, 31 aa, Artificial
  8Aib,22Aib,35Aib-GLP-1(7-37)
HXEGTFTSDVSSYLEXQAAKEFIAWLVKXRG

SEQ ID NO: 50 - protein, 31 aa, Artificial
  22E,23E-GLP-1(7-37)
HAEGTFTSDVSSYLEEEAAKEFIAWLVKGRG

SEQ ID NO: 51 - protein, 31 aa, Artificial
  8G,22E,23E-GLP-1(7-37)
HGEGTFTSDVSSYLEEEAAKEFIAWLVKGRG

SEQ ID NO: 52 - protein, 31 aa, Artificial
  8V,22E,23E-GLP-1(7-37)
HVEGTFTSDVSSYLEEEAAKEFIAWLVKGRG

SEQ ID NO: 53 - protein, 31 aa, Artificial
  8V,22E,25V-GLP-1(7-37)
HVEGTFTSDVSSYLEEQAVKEFIAWLVKGRG

SEQ ID NO: 54 - protein, 31 aa, Artificial
  8V,22E,33I-GLP-1(7-37)
HVEGTFTSDVSSYLEEQAAKEFIAWLIKGRG

SEQ ID NO: 55 - protein, 31 aa, Artificial
  8V,22E,25V,33I-GLP-1(7-37)
HVEGTFTSDVSSYLEEQAVKEFIAWLIKGRG

SEQ ID NO: 56 - protein, 39 aa, Heloderma horridum
  Exendin-3
HSDGTFTSDLSKQMEEEAVRLFIEWLKNGGPSSGAPPPS

SEQ ID NO: 57 - protein, 39 aa, Heloderma suspectum
  Exendin-4
HGEGTFTSDLSKQMEEEAVRLFIEWLKNGGPSSGAPPPS

SEQ ID NO: 58 - protein, 44 aa, Artificial
  Exendin-4-KKKKK
HGEGTFTSDLSKQMEEEAVRLFIEWLKNGGPSSGAPPPSKKKKK

SEQ ID NO: 59 - protein, 45 aa, Artificial
  Exendin-4-KKKKKK
HGEGTFTSDLSKQMEEEAVRLFIEWLKNGGPSSGAPPPSKKKKKK

SEQ ID NO: 60 - protein, 30 aa, Artificial
  Exendin-4(1-30)
HGEGTFTSDLSKQMEEEAVRLFIEWLKNGG

SEQ ID NO: 61 - protein, 28 aa, Artificial
  Exendin-4(1-28)
HGEGTFTSDLSKQMEEEAVRLFIEWLKN

SEQ ID NO: 62 - protein, 39 aa, Artificial
  14L,25F-Exendin-4
HGEGTFTSDLSKQLEEEAVRLFIEFLKNGGPSSGAPPPS

SEQ ID NO: 63 - protein, 28 aa, Artificial
  14L,25F-Exendin-4(1-28)
HGEGTFTSDLSKQLEEEAVRLFIEFLKN

SEQ ID NO: 64 - protein, 33 aa, Homo sapiens
  GLP-2
HADGSFSDEMNTILDNLAARDFINWLIQTKITD

SEQ ID NO: 65 - protein, 31 aa, Homo sapiens
  GLP-2(3-33)
DGSFSDEMNTILDNLAARDFINWLIQTKITD

SEQ ID NO: 66 - protein, 33 aa, Artificial
  2S-GLP-2
HSDGSFSDEMNTILDNLAARDFINWLIQTKITD

SEQ ID NO: 67 - protein, 33 aa, Artificial
  2G-GLP-2
HGDGSFSDEMNTILDNLAARDFINWLIQTKITD

SEQ ID NO: 68 - protein, 33 aa, Artificial
  2V-GLP-2
HVDGSFSDEMNTILDNLAARDFINWLIQTKITD

SEQ ID NO: 69 - protein, 29 aa, Homo sapiens
  Glucagon
HSQGTFTSDYSKYLDSRRAQDFVQWLMNT

SEQ ID NO: 70 - protein, 29 aa, Artificial
  12R-Glucagon
HSQGTFTSDYSRYLDSRRAQDFVQWLMNT

SEQ ID NO: 71 - protein, 29 aa, Artificial
  12R,20K-Glucagon
HSQGTFTSDYSRYLDSRRAKDFVQWLMNT

SEQ ID NO: 72 - protein, 29 aa, Artificial
  12R,24K-Glucagon
HSQGTFTSDYSRYLDSRRAQDFVKWLMNT

SEQ ID NO: 73 - protein, 29 aa, Artificial
  12R,29K-Glucagon
HSQGTFTSDYSRYLDSRRAQDFVQWLMNK

SEQ ID NO: 74 - protein, 29 aa, Artificial
  9E-Glucagon
HSQGTFTSEYSKYLDSRRAQDFVQWLMNT

SEQ ID NO: 75 - protein, 29 aa, Artificial
  9E,16E,29K-Glucagon
HSQGTFTSEYSKYLDERRAQDFVQWLMNK

SEQ ID NO: 76 - protein, 29 aa, Artificial
  13K,17E-Glucagon
HSQGTFTSDYSKKLDSERAQDFVQWLMNT

SEQ ID NO: 77 - protein, 29 aa, Artificial
  20E,24K-Glucagon
HSQGTFTSDYSKYLDSRRAEDFVKWLMNT

SEQ ID NO: 78 - protein, 9 aa, Artificial
  GIP(1-9) Analogs
XXXGTFISX

SEQ ID NO: 79 - protein, 8 aa, Artificial
  2G-GIP(1-8)
YGEGTFIS

SEQ ID NO: 80 - protein, 8 aa, Artificial
  D2A-GIP(1-8)
YXEGTFIS

SEQ ID NO: 81 - protein, 8 aa, Artificial
  2Abu-GIP(1-8)
YXEGTFIS

SEQ ID NO: 82 - protein, 8 aa, Artificial
  2Aib-GIP(1-8)
YXEGTFIS

SEQ ID NO: 83 - protein, 8 aa, Artificial
  2PS-GIP(1-8)
YXEGTFIS

SEQ ID NO: 84 - protein, 8 aa, Artificial
  2Sar-GIP(1-8)
YXEGTFIS

SEQ ID NO: 85 - protein, 8 aa, Artificial
  3P-GIP(1-8)
YAPGTFIS

SEQ ID NO: 86 - protein, 8 aa, Artificial
  3Hyp-GIP(1-8)
YAXGTFIS

SEQ ID NO: 87 - protein, 8 aa, Artificial
  3K-GIP(1-8)
YAKGTFIS

SEQ ID NO: 88 - protein, 8 aa, Artificial
  3Y-GIP(1-8)
YAYGTFIS

SEQ ID NO: 89 - protein, 8 aa, Artificial
  3F-GIP(1-8)
YAFGTFIS

SEQ ID NO: 90 - protein, 9 aa, Artificial
  2G-GIP(1-9)
YGEGTFISD

SEQ ID NO: 91 - protein, 9 aa, Artificial
  2S-GIP(1-9)
YSEGTFISD

SEQ ID NO: 92 - protein, 9 aa, Artificial
  D2A-GIP(1-9)
YXEGTFISD

SEQ ID NO: 93 - protein, 9 aa, Artificial
  2Abu-GIP(1-9)
YXEGTFISD

SEQ ID NO: 94 - protein, 9 aa, Artificial
  2Aib-GIP(1-9)
YXEGTFISD

SEQ ID NO: 95 - protein, 9 aa, Artificial
  2PS-GIP(1-9)
YXEGTFISD

SEQ ID NO: 96 - protein, 9 aa, Artificial
  2Sar-GIP(1-9)
YXEGTFISD

SEQ ID NO: 97 - protein, 9 aa, Artificial
  3P-GIP(1-9)
YAPGTFISD

SEQ ID NO: 98 - protein, 9 aa, Artificial
  3Hyp-GIP(1-9)
YAXGTFISD

SEQ ID NO: 99 - protein, 9 aa, Artificial
  3K-GIP(1-9)
YAKGTFISD

SEQ ID NO: 100 - protein, 9 aa, Artificial
  3Y-GIP(1-9)
YAYGTFISD

SEQ ID NO: 101 - protein, 9 aa, Artificial
  3F-GIP(1-9)
YAFGTFISD

SEQ ID NO: 102 - protein, 9 aa, Artificial
  GLP-1(7-15) Analogs
HXXGTFTSX

SEQ ID NO: 103 - protein, 8 aa, Artificial
  2G-GLP-1(7-14)
HGEGTFTS

SEQ ID NO: 104 - protein, 8 aa, Artificial
  2V-GLP-1(7-14)
HVEGTFTS

SEQ ID NO: 105 - protein, 8 aa, Artificial
  2Aib-GLP-1(7-14)
HXEGTFTS

SEQ ID NO: 106 - protein, 9 aa, Artificial
  2S-GLP-1(7-15)
HSEGTFTSD

SEQ ID NO: 107 - protein, 9 aa, Artificial
  2G-GLP-1(7-15)
HGEGTFTSD

SEQ ID NO: 108 - protein, 9 aa, Artificial
  2V-GLP-1(7-15)
HVEGTFTSD

SEQ ID NO: 109 - protein, 9 aa, Artificial
  2Aib-GLP-1(7-15)
HXEGTFTSD

SEQ ID NO: 110 - protein, 7 aa, Artificial
  GLP-2(1-7)
HADGSFS

SEQ ID NO: 111 - protein, 8 aa, Artificial
  GLP-2(1-8)
HADGSFSD

SEQ ID NO: 112 - protein, 16 aa, Artificial
  GIP(1-16)
YAEGTFISDYSIAMDK

SEQ ID NO: 113 - protein, 42 aa, Artificial
  2S-GIP
YSEGTFISDYSIAMDKIHQQDFVNWLLAQKGKKNDWKHNITQ

(19) United States
(12) Patent Application Publication
(10) Pub. No.: US 2013/0344524 A1
(43) Pub. Date: Dec. 26, 2013

(54) ANALYSIS METHOD

(71) Applicants: Atsushi Miyachi, Nagoya-shi (JP); Yoshika Yasuda, Nagoya-shi (JP); Hiroko Hirooka, Nagoya-shi (JP)

(72) Inventors: Atsushi Miyachi, Nagoya-shi (JP); Yoshika Yasuda, Nagoya-shi (JP); Hiroko Hirooka, Nagoya-shi (JP)

(73) Assignee: SANWA KAGAKU KENKYUSHO CO., LTD., Nagoya-shi (JP)

(21) Appl. No.: 14/003,704

(22) PCT Filed: Mar. 7, 2012
(86) PCT No.: PCT/JP2012/055873

§ 371 Date: Sep. 6, 2013

(30) Foreign Application Priority Data
Mar. 8, 2011 (JP) 2011-049726

(51) Int. Cl. G01N 27/62

(52) U.S. Cl. CPC G01N 27/62
USPC 435/23; 436/87

(57) ABSTRACT

In a method for detecting a glucagon-secretin family peptide in a sample, the sample is contacted with a cleaving agent capable of digesting the glucagon-secretin family peptide by cleaving a peptide bond of at least one aspartic acid within the glucagon-secretin family peptide and thereby generating a plurality of peptide fragments, at least one of the peptide fragments containing an N-terminal end of the glucagon-secretin family peptide. The peptide fragment that contains the N-terminal end of the glucagon-secretin family peptide is then detected using liquid chromatography and mass spectrometry. The amount of peptide fragment that contains the N-terminal end of the glucagon-secretin family peptide in the sample can then be quantitated using a calibration curve.

### TECHNICAL FIELD

The present invention relates to an analysis method for glucagon-secretin family peptides and a quantitative method for glucagon-secretin family peptides in a sample using this analysis method.

### BACKGROUND ART

Glucagon-secretin family peptide is a generic name for peptides which have a high amino acid sequence homology to glucagon and the like. An accurate understanding of the concentration of glucagon-secretin family peptide in vivo, etc. is important in function studies, in understanding the disease status of patients and in the development of drugs for ameliorating diseases.

Quantitative methods using antibodies are common as quantitative methods for glucagon-secretin family peptides, as exemplified by e.g. enzyme-linked immunosorbent assay (ELISA) and radioimmunoassay (RIA). To prepare the antibodies, however, a long period of time and high costs are required. Even if the antibodies can be obtained, a problem of cross-reactivity can occur, in which the antibodies also react with other biologically-active substances that have a high homology to the peptides.

Quantitative methods for glucagon-secretin family peptides using mass spectrometry (MS) have been reported in recent years (Non-patent Documents 1 to 3, Patent Document 1). However, non-patent Documents 1 and 2 use antibodies as a pretreatment, and Patent Document 1 and Non-patent Document 3 have not been satisfactory in terms of quantitative sensitivity and the like.

### CITATION LIST

### Patent Literature

Patent Document 1: International Publication No. WO 2008/154619 A

### Non Patent Literature

Non-patent Document 1: J Chromatogr A, 2001, 926, 21

Non-patent Document 2: J Chromatogr B, 2004, 803, 91

Non-patent Document 3: J Proteome Res, 2009, 8, 3487

### SUMMARY OF THE INVENTION

### Problem(s) to be Solved by the Invention

The quantitative methods using mass spectrometry have not been satisfactory in terms of quantitative sensitivity; the present circumstances require the establishment of a quantitative method using a trace amount of sample. Furthermore, after a sample has been prepared for mass spectrometry, if it is stored for several days before the measurement, changes of the measured values may occur. The present invention has been made in view of the above, and an object thereof is to provide a method in which glucagon-secretin family peptides can be stably analyzed under conditions in which the measurement sample is less prone to undergo e.g. chemical changes during storage and under practical conditions.

### Means for Solving the Problem(s)

The present inventors noticed that in some cases, the measured values of the mass spectrometry were stable and in other cases, the values were not stable depending on the peptide fragments to be measured. In addition, when analyzing the glucagon-secretin family peptides, it was discovered that the selection of the peptide fragment to be analyzed was important. That is, the present analysis method is mainly characterized by cleaving the peptide bond of aspartic acid within the glucagon-secretin family peptide and selecting the peptide fragment of the N-terminal end of the glucagon-secretin family peptide for measurement.

The principle constitutions of the present invention are as follows.

(1) An analysis method for a glucagon-secretin family peptide in a sample, the method comprising a cleavage step of cleaving a peptide bond of aspartic acid of the glucagon-secretin family peptide in the sample to obtain peptide fragments; a separation/purification step of separating and purifying the peptide fragments cleaved in the cleavage step using liquid chromatography to select a peptide fragment, a substance to be measured, of an N-terminal end of the glucagon-secretin family peptide; and an analysis step of carrying out mass spectrometry on the separated and purified peptide fragment to detect the peptide fragment of the N-terminal end of the glucagon-secretin family peptide.

(2) The analysis method according to (1), wherein the peptide bond of aspartic acid is cleaved using a cleaving agent selected from a site-specific protease and an acid in the cleavage step.

(3) The analysis method according to (2), wherein the cleaving agent is selected from the group consisting of endopeptidase ASP-N, formic acid, acetic acid, trifluoroacetic acid, propionic acid and combinations thereof.

(4) The analysis method according to any of (1) to (3), wherein the liquid chromatography in the separation/purification step is liquid chromatography having a flow rate of 50 nL/min to 50 μL/min.

(5) The analysis method according to any of (1) to (4), wherein the glucagon-secretin family peptide is selected from the group consisting of glucose-dependent insulinotropic polypeptide, glucagon-like peptide-1, glucagon-like peptide-2, glucagon and analogs thereof.

(6) The analysis method according to any of (1) to (5), wherein the peptide fragment to be measured is selected in the separation/purification step by mass selection of a precursor ion.

(7) The analysis method according to any of (1) to (6), further comprising a step of solid-phase extraction of the peptide fragment in the separation/purification step.

(8) The analysis method according to any of (1) to (7), wherein the separation/purification step and the analysis step are carried out using high performance liquid chromatography/mass spectrometry/mass spectrometry/mass spectrometry.

(9) A quantitative method for a glucagon-secretin family peptide in a sample, wherein a calibration curve is made using the analysis method according to any of (1) to (8) and the glucagon-secretin family peptide in the sample is quantitated using the calibration curve.

(10) The quantitative method according to (9), wherein two or more glucagon-secretin family peptides in the sample are distinguished and simultaneously quantitated by simultaneously measuring each peptide fragment of two or more glucagon-secretin family peptides.

(11) The quantitative method according to (9) or (10), wherein active and inactive glucagon-secretin family peptides in the sample are distinguished and simultaneously quantitated by simultaneously measuring each peptide fragment of the active glucagon-secretin family peptide and the inactive glucagon-secretin family peptide.

(12) The quantitative method according to any of (9) to (11), wherein a stable isotope-labeled internal standard is added to the sample to make the calibration curve.

(13) The quantitative method according to (12), wherein the quantitative determination is carried out using a peak area ratio of each of the peptide fragment and the internal standard peptide fragment.

(14) The quantitative method according to (12) or (13), wherein the internal standard is a peptide in which one or more amino acids selected from positions 1-15 of the glucagon-secretin family peptide is (are) substituted with (a) stable isotope-labeled amino acid(s).

(15) A quantitative kit for a glucagon-secretin family peptide, the kit comprising (a) a matrix for control, (b) an internal standard or solution thereof, (c) glucagon-secretin family peptides or standard thereof, or solution thereof, (d) a cleaving agent, and (e) a solid phase extraction plate.

(16) The quantitative method according to (15), wherein the cleaving agent is selected from the group consisting of endopeptidase ASP-N, formic acid, acetic acid, trifluoroacetic acid, propionic acid and combinations thereof.

(17) The quantitative method according to (15) or (16), wherein the glucagon-secretin family peptide is selected from the group consisting of glucose-dependent insulinotropic polypeptide, glucagon-like peptide-1, glucagon-like peptide-2, glucagon and analogs thereof.

### Effects of the Invention

According to the present invention, glucagon-secretin family peptides can be accurately analyzed even after a lapse of time from preparation. Alternatively, a trace amount of glucagon-secretin family peptide in a sample can be quantitated with high sensitivity, and the reproducibility of the quantitative values is good.

### BRIEF DESCRIPTION OF THE DRAWINGS

FIG. 1 is a chromatogram when an LC/MS analysis is carried out immediately after two types of peptide fragments are mixed in equal amounts.

FIG. 2 is a chromatogram when an LC/MS analysis is carried out on the 17^{th} day after two types of peptide fragments were mixed in equal amounts and refrigerated.

FIG. 3 is a chromatogram when a GIP analog is cleaved by endopeptidase Asp-N.

FIG. 4 is chromatograms when GIP is cleaved using 2% formic acid.

FIG. 5 is chromatograms when GIP is cleaved using 2% acetic acid.

FIG. 6 is chromatograms when GIP is cleaved using 1% trifluoroacetic acid.

FIG. 7 is a chromatogram when GLP-1 is cleaved by endopeptidase Asp-N.

FIG. 8 is a chromatogram when glucagon is cleaved by endopeptidase Asp-N.

FIG. 9 is a chromatogram when a GLP-1 analog is cleaved by endopeptidase Asp-N.

FIG. 10 is chromatograms of an active GIP peptide fragment and a corresponding internal standard when active GIP is quantitated.

FIG. 11 is a graph showing a calibration curve of active GIP in the quantitative determination of active GIP.

FIG. 12 is chromatograms of an active GIP peptide fragment and a corresponding internal standard when active GIP and non-active GIP are simultaneously quantitated.

FIG. 13 is chromatograms of an inactive GIP peptide fragment and a corresponding internal standard when active GIP and inactive GIP are simultaneously quantitated.

FIG. 14 is a graph showing a calibration curve of active GIP in the simultaneous quantitative determination of active GIP and inactive GIP.

FIG. 15 is a graph showing a calibration curve of non-active GIP in the simultaneous quantitative determination of active GIP and inactive GIP.

FIG. 16 is chromatograms of active GIP when active GIP and inactive GIP in a plasma sample from a diabetic patient are simultaneously quantitated.

FIG. 17 is chromatograms of inactive GIP when active GIP and inactive GIP in a plasma sample from a diabetic patient are simultaneously quantitated.

### MODES FOR CARRYING OUT THE INVENTION

Hereinafter embodiments of the present invention will be described in more detail. It should be noted, however, that the present invention is not restricted to the following embodiments.

Glucagon-secretin family peptides analyzed in the present invention are peptides that have a high amino acid sequence homology to glucagon and the like. Glucagon-secretin family peptides defined herein include analogs thereof. Glucagon-secretin family peptides include glucose-dependent insulinotropic polypeptide (GIP), glucagon-like peptide-1 (GLP-1), glucagon-like peptide-2 (GLP-2), glucagon and the like. Among these, GIP and GLP-1 are known as incretin. Those which are inherent in vivo, those which are artificially synthesized and variants thereof are included herein.

Glucagon-secretin family peptide analogs are peptides in which one or more amino acids are deleted, substituted or added (e.g. inserted) in the amino acid sequences of glucagon-secretin family peptides, wherein the analogs have substantially the same activity as glucagon-secretin family peptides. The amino acid sequences of glucagon-secretin family peptide analogs preferably have a homology of not less than 80% with the amino acid sequences of glucagon-secretin family peptides. Such peptide design is intended to increase efficacy, to enhance selectivity and for stabilization against peptide degradation, and varies depending on types of glucagon-secretin family peptides, and can be performed using methods known to those of skill in the art. In glucagon-secretin family peptides, sugar chains, fatty acids, lipids, nucleic acids and the like can be bound to their peptide chains. That is, the glucagon-secretin family peptide analogs include glucagon-secretin family peptide derivatives, as well as modified, chimera and hybrid forms.

Glucose-dependent insulinotropic polypeptide (hereinafter referred to as GIP) is an active GIP which consists of 42 amino acids, and is commonly expressed as GIP₁₋₄₂ [SEQ ID NO: 13]. Two amino acid residues on the N-terminal end of the active GIP are cleaved by DPP-IV to form inactive GIP₃₋₄₂ [SEQ ID NO.: 14]. Accordingly, active GIP and inactive GIP can be distinguished and simultaneously analyzed or quantitated by measuring peptide fragments on the N-terminal end of GIP. In GIP, one or more amino acids are substituted depending on the species such as human, mouse or rat. Human active GIP is a peptide consisting of the following sequence, and His at position 18 is substituted with Arg in mouse and rat.

[SEQ ID NO.: 13]
Tyr-Ala-Glu-Gly-Thr-Phe-Ile-Ser-Asp-Tyr-Ser-Ile-Ala-Met-Asp-Lys-Ile-His-Gln-Gln-Asp-
Phe-Val-Asn-Trp-Leu-Leu-Ala-Gln-Lys-Gly-Lys-Lys-Asn-Asp-Trp-Lys-His-Asn-Ile-Thr-Gln

Specifically, the following are well known as GIP analogs. Further, inactive GIP analogs include peptides in which the two amino acid residues on the N-terminal end of GIP analogs have been cleaved (the sequence ID number of a partly modified form, in which the amino acid sequence is not changed, is omitted).

[N-Acetyl]-GIP [N-Acetyl variant of SEQ ID NO.: 13], [N-Pyroglutamyl]-GIP [N-Pyroglutamyl variant of SEQ ID NO.: 13], [N-Glucitol]-GIP [N-Glucitol variant of SEQ ID NO.: 13], [N-Palmitate]-GIP [N-Palmitate variant of SEQ ID NO.: 13], [N-Fmoc]-GIP [N-Fmoc variant of SEQ ID NO.: 13], [N-alkyl]-GIP [N-alkyl variant of SEQ ID NO.: 13], [N-glycosyl]-GIP [N-glycosyl variant of SEQ ID NO.: 13], [N-isopropyl]-GIP [N-isopropyl variant of SEQ ID NO.: 13], [Gly2]-GIP [SEQ ID NO.: 15], [D-Ala2]-GIP [SEQ ID NO.: 16] (note that D-Ala means D-alanine This also applies in the following.), [Aib2]-GIP [SEQ ID NO.: 17] (note that Aib means Aminoisobutylic acid. This also applies in the following.), [Phosphoserine2]-GIP [SEQ ID NO.: 18], [Sar2]-GIP [SEQ ID NO.: 19] (note that Sar means N-Methylglycine (MeGly), sarcosine. This also applies in the following.), [Pro3]-GIP [SEQ ID NO.: 20], [Hyp3]-GIP [SEQ ID NO.: 21] (note that Hyp means Hydroxyproline. This also applies in the following.), [Lys3]-GIP [SEQ ID NO.: 22], [Tyr3]-GIP [SEQ ID NO.: 23], [Phe3]-GIP [SEQ ID NO.: 24], [Ser2]-GIP [SEQ ID NO.: 113]

As glucagon-like peptide-1 (hereinafter referred to as GLP-1), GLP-1 (7-36) [SEQ ID NO.: 25] amide and GLP-1 (7-37) [SEQ ID NO.: 26] amide are commonly known as active forms thereof. International Patent Application No. 91/11457 has reported that GLP-1 (7-34) [SEQ ID NO.: 27] and GLP-1 (7-35) [SEQ ID NO.: 28] also have activity. Since the N-terminus of the GLP-1 precursor is generally expressed as position 1, the N-terminus of the active GLP-1 is at position 7. As is the case with GIP, active GLP-1 loses its activity upon cleavage of the two amino acid residues on the N-terminal side by DPP-IV to form GLP-1 (9-36) [SEQ ID NO.: 29], GLP-1 (9-37) [SEQ ID NO.: 30] and the like. Accordingly, active GLP-1 and inactive GLP-1 can be distinguished and simultaneously analyzed or quantitated by measuring the fragment on the N-terminal end of GLP-1. GLP-1 (7-37) is a peptide consisting of the following sequence.

[SEQ ID NO.: 26]
His-Ala-Glu-Gly-Thr-Phe-Thr-Ser-Asp-Val-Ser-Ser-
Tyr-Leu-Glu-Gly-Gln-Ala-Ala-Lys-Glu-Phe-Ile-Ala-
Trp-Leu-Val-Lys-Gly-Arg-Gly

Specifically, the following are well known as GLP-1 analogs. Further, inactive GLP-1 analogs include peptides in which the two amino acid residues on the N-terminal end of GLP-1 analogs have been cleaved.

[Ser8]-GLP-1 (7-37) [SEQ ID NO.: 31], [Gly8]-GLP-1 (7-37) [SEQ ID NO.: 32], [Val8]-GLP-1 (7-37) [SEQ ID NO.: 33], [Glu22]-GLP-1 (7-37) [SEQ ID NO.: 34], [Lys22]-GLP-1 (7-37) [SEQ ID NO.: 35], [Val8, Glu22]-GLP-1 (7-37) [SEQ ID NO.: 36], [Val8, Lys22]-GLP-1 (7-37) [SEQ ID NO.: 37], [Gly8, Glu22]-GLP-1 (7-37) [SEQ ID NO.: 38], [Gly8, Lys22]-GLP-1 (7-37) [SEQ ID NO.: 39], [Val8, Glu30]-GLP-1 (7-37) [SEQ ID NO.: 40], [Gly8, Glu30]-GLP-1 (7-37) [SEQ ID NO.: 41], [Val8, His37]-GLP-1 (7-37) [SEQ ID NO.: 42], [Gly8, His37]-GLP-1 (7-37) [SEQ ID NO.: 43], [Arg34]-GLP-1 (7-37) [SEQ ID NO.: 44], [Lys18]-GLP-1 (7-37) [SEQ ID NO.: 45], [Gly8, Glu22, Gly36]-GLP-1 (7-37) [SEQ ID NO.: 46], [Aib8, Aib22]-GLP-1 (7-37) [SEQ ID NO.: 47], [Aib8, Aib35]-GLP-1 (7-37) [SEQ ID NO.: 48], [Aib8, Aib22, Aib35]-GLP-1 (7-37) [SEQ ID NO.: 49], [Glu22, Glu23]-GLP-1 (7-37) [SEQ ID NO.: 50], [Gly8, Glu22, Glu23]-GLP-1 (7-37) [SEQ ID NO.: 51], [Val8, Glu22, Glu23]-GLP-1 (7-37) [SEQ ID NO.: 52], [Val8, Glu22, Val25]-GLP-1 (7-37) [SEQ ID NO.: 53], [Val8, Glu22, Ile33]-GLP-1 (7-37) [SEQ ID NO.: 54], [Val8, Glu22, Val25, Ile33]-GLP-1 (7-37) [SEQ ID NO.: 55], and the GLP-1 (7-36) type in which the residue at position 37 thereof has been deleted, and the GLP-1 (7-35) type in which the residues at positions 36 and 37 thereof have been deleted

Further, exendin is known as a GLP-1 receptor agonist, and is also included within GLP-1 analogs. Exendin analogs are known, such as Exendin-3 [SEQ ID NO.: 56], Exendin-3 amide [the C-terminal amide derivative of the same sequence as SEQ ID NO.: 56], Exendin-4 [SEQ ID NO.: 57], Exendin-4 amide [the C-terminal amide derivative of the same sequence as SEQ ID NO.: 57], Exendin-4 acid [an acid variant of the same sequence as SEQ ID NO.: 57], Exendin-4-LysLysLysLysLys [SEQ ID NO.: 58], Exendin-4-LysLysLysLysLysLys [SEQ ID NO.: 59], Exendin-4 (1-30) [SEQ ID NO.: 60], Exendin-4 amide (1-30) [the C-terminal amide derivative of the same sequence as SEQ ID NO.: 60], Exendin-4 (1-28) [SEQ ID NO.: 61], Exendin-4 amide (1-28) [the C-terminal amide derivative of the same sequence as SEQ ID NO.: 61], ¹⁴Leu²⁵Phe-Exendin-4 amide [the C-terminal amide derivative of the same sequence as SEQ ID NO.: 62] and ¹⁴Leu²⁵Phe-Exendin-4 amide (1-28) [the C-terminal amide derivative of SEQ ID NO.: 63]. Other analogs are specifically disclosed in e.g. International Publication No. WO 2009/035540. Exendin-4 is a biologically-active peptide having GLP-1-like activity, which was discovered from the salivary gland secretions of Heloderma suspectum.

Glucagon-like peptide-2 (hereinafter referred to as GLP-2) is an intestinotrophic peptide hormone with 33 amino acids which is produced by post-translational processing of proglucagon, and is commonly expressed as GLP-2 [SEQ ID NO.: 64]. As is the case with GIP, GLP-2 loses its activity upon cleavage of the two amino acid residues on the N-terminal side by DPP-IV to form inactive GLP-2 (3-33) [SEQ ID NO.: 65]. Active GLP-2 and inactive GLP-2 can be distinguished and simultaneously analyzed or quantitated by measuring fragments on the N-terminal GLP-2. Specifically, the following are well known as GLP-2 analogs. Further, inactive GLP-2 analogs include peptides in which the two amino acid residues on the N-terminal end of GLP-2 peptides are hydrolyzed.

[Ser2]-GLP-2 [SEQ ID NO.: 66], [Gly2]-GLP-2 [SEQ ID NO.: 67], [Val2]-GLP-2 [SEQ ID NO.: 68]

Glucagon is a peptide hormone consisting of 29 amino acids, and is commonly expressed as glucagon [SEQ ID NO.: 69]. Specifically, the following are well known as glucagon analogs.

[Arg12]-Glucagon [SEQ ID NO.: 70], [Arg12, Lys20]-Glucagon [SEQ ID NO.: 71], [Arg12, Lys24]-Glucagon [SEQ ID NO.: 72], [Arg12, Lys29]-Glucagon [SEQ ID NO.: 73], [Glu9]-Glucagon [SEQ ID NO.: 74], [Glu9, Glu16, Lys29]-Glucagon [SEQ ID NO.: 75], [Lys13, Glu17]-Glucagon [SEQ ID NO.: 76], [Glu20, Lys24]-Glucagon [SEQ ID NO.: 77]

Samples include biological samples such as blood, serum, plasma, urine, saliva, exudates and tissue extracts, medicines and in vitro samples such as cell culture fluids. Preferably, glucagon-secretin family peptides can be quantitated using a sample of 5 μL to 5 mL and a concentration range of 0.1 pM to 500 pM, and more preferably can be quantitated using a sample of 10 μL to 3 mL and a concentration range of 0.5 pM to 200 pM. If glucagon-secretin family peptides can be quantitated using a sample of 5 mL or less, the burden on the patient can be reduced because the amount of blood to be collected can be decreased, and the extraction procedure is not complicated. In case the sample is plasma, preferably the above-mentioned quantitative determination can be carried out using plasma of 5 μL to 500 μL and a concentration range of 0.1 pM to 500 pM, and more preferably can be carried out using plasma of 10 μL to 300 μL and a concentration range of 0.5 pM to 200 pM.

Peptide fragments of a glucagon-secretin family peptide mean peptides after the glucagon-secretin family peptide has been cleaved by some type of method, and refers to consecutive segments of the amino acid sequence of the glucagon-secretin family peptide. In the present analysis method, the peptide bond of aspartic acid (Asp) in the amino acid sequence of the glucagon-secretin family peptide is cleaved, and from among the resulting peptide fragments, the peptide fragment of the N-terminal end of the glucagon-secretin family peptide is subjected to mass spectrometry. With respect to this cleavage, the N-terminal side of aspartic acid can be cleaved or the C-terminal side thereof can be cleaved. By using such peptide fragments, stable measured values are easily obtained, and sensitivity is improved. In addition, the analysis using mass spectrometry can be carried out without using antibodies. Further, multiply-charged ions are less prone to occur, and the effect of species differences can be reduced. In GIP, for example, positions 1-17 of the amino acid sequence have a high homology and are identical in human, rat and mouse. For storage stability, it is important that the peptide fragment to be measured does not comprise an easily-oxidized amino acid. The easily-oxidized amino acids are methionine (Met), tryptophan (Trp) and cysteine (Cys). Peptide fragments of the N-terminal end of glucagon-secretin family peptides do not comprise the above-mentioned amino acids, and thus storage stability is good. When the glucagon-secretin family peptides are different, the peptide fragments in the present method are different. It is believed that a peptide having the same sequence as the peptide of the N-terminal end, which has been cleaved at aspartic acid, of a glucagon-secretin family peptide does not exist in vivo. Because of the above-mentioned two points, peptide fragments of the N-terminal end of glucagon-secretin family peptides can be distinguished by mass spectrometry and can be analyzed with high specificity.

The peptide bond of aspartic acid in the amino acid sequences can be cleaved using substances (cleaving agents) which cleave a peptide bond. The substances which cleave a peptide bond can include site-specific proteases, acids or the like. An example of a site-specific protease is endopeptidase Asp-N. Endopeptidase Asp-N hydrolyzes the peptide bond on the N-terminal side of aspartic acid (Asp). As the acids, there are organic acids, inorganic acids and the like. Examples of organic acids include carboxylic acids such as formic acid, acetic acid, propionic acid, hexanoic acid, citric acid, chloroacetic acid, dichloroacetic acid, trichloroacetic acid, trifluoroacetic acid (TFA), benzoic acid, salicylic acid, oxalic acid, succinic acid, malonic acid, phthalic acid, tartaric acid, malic acid and glycolic acid; sulfonic acids such as methanesulfonic acid, benzenesulfonic acid, p-toluenesulfonic acid and trifluoromethanesulfonic acid; and the like. Examples of inorganic acids include hydrochloric acid, hydrobromic acid, sulfuric acid, phosphoric acid, tetrafluoroboric acid, perchloric acid, periodic acid and the like. These acids can be used individually or two or more acids can be suitably combined. Among these cleaving agents, any one selected from the group consisting of endopeptidase ASP-N, formic acid, acetic acid, trifluoroacetic acid, propionic acid and combinations thereof is preferred. When an acid is used as the cleaving agent, a 1 to 2% organic acid is commonly used in an amount of preferably 10 μL to 3 mL, and more preferably 100 μL to 1 mL, per 5 nmol of the glucagon-secretin family peptide. The acidity for cleavage is preferably pH 1 to 5 and more preferably pH 2 to 4. By using these acids, the peptide bond on the C-terminal side or the N-terminal side of aspartic acid (Asp) can be hydrolyzed, and the analysis and quantitative determination can be carried out using the hydrolyzed peptide fragment of the N-terminal end of the glucagon-secretin family peptide.

When a glucagon-secretin family peptide is cleaved using a site-specific protease, the reaction temperature is usually 25 to 45° C., and preferably 35 to 40° C. The reaction time is usually 4 to 24 hours, and preferably 10 to 18 hours. When a glucagon-secretin family peptide is cleaved using an acid, the reaction temperature is usually 60 to 120° C., and preferably 95 to 110° C. The reaction time is usually 30 minutes to 24 hours, and preferably 2 to 20 hours. A solvent can be used in any reaction, and any solvent that does not inhibit the reaction can be used.

When the peptide bonds of aspartic acid (Asp) in two or more glucagon-secretin family peptides are cleaved, two or more glucagon-secretin family peptides can be distinguished and simultaneously analyzed by measuring the peptide fragments on the N-terminal side. In this case, it is preferred to select two or more glucagon-secretin family peptides which have the same extraction conditions.

The amino acid sequences on the N-terminal side are important to the physiological activity of glucagon-secretin family peptides. That is, in some glucagon-secretin family peptides, the two amino acid residues on the N-terminal side are lost by an enzyme such as dipeptidil peptidase-4 (hereinafter, referred to as DPP-4) to lose activity. In GIP₁₋₄₂ of the active GIP, for example, the two residues (Tyr at position 1 and Ala at position 2) on the N-terminal side are cleaved by DPP-4 to form GIP₃₋₄₂ and its activity is lost. Accordingly, by measuring peptide fragments on the N-terminal end of glucagon-secretin family peptides, active glucagon-secretin family peptides, in which two residues on the N-terminal side remain, and inactive glucagon-secretin family peptides, in which two residues on the N-terminal side are lost, can be distinguished and quantitated. If the active type and the inactive type can be distinguished and quantitated, both the active and the inactive glucagon-secretin family peptides can be simultaneously quantitated.

To improve the specificity of the measurement using mass spectrometry, the number of amino acids in the peptide to be measured is preferably 5 to 14, and more preferably 6 to 9. The peptide fragments in the present method are in this numerical range, and are suitable for measurement using mass spectrometry.

Peptide fragments on the N-terminal end of GIP or analogs thereof can be expressed by the following formula.

[SEQ ID NO.: 78]
Formula: X₁-X₂-X₃-Gly-Thr-Phe-Ile-Ser-X₄

[wherein:
X₁ means Tyr, D-Tyr, N-Acetyl-Tyr, N-Pyroglutamyl-Tyr, N-Glucitol-Tyr, N-Palmitate-Tyr, N-Fmoc-Tyr, N-alkyl-Tyr, N-glycosyl-Tyr, N-isopropyl-Tyr or omitted,
X₂ means Ala, D-Ala, Gly, Ser, 2-Aminobutylic acid, Aminoisobutylic acid, Phosphoserine, Sarcosine, or omitted,
X₃ means Glu, D-Glu, Pro, Hydroxyproline, Lys, Tyr, or Phe, and
X₄ means Asp or omitted.]

Specific examples of peptide fragments of the N-terminal end of GIP or analogs thereof are as follows. Those, in which the two amino acid residues on the N-terminal side of the following peptide fragments on the N-terminal GIP or analogs thereof have been deleted, are inactive peptide fragments.

[SEQ ID NO.: 1]
Tyr-Ala-Glu-Gly-Thr-Phe-Ile-Ser,
[N-Acetyl variant of SEQ ID NO.: 1]
N-Acetyl-Tyr-Ala-Glu-Gly-Thr-Phe-Ile-Ser,
[N-Pyroglutamyl variant of SEQ ID NO.: 1]
N-Pyroglutamyl-Tyr-Ala-Glu-Gly-Thr-Phe-Ile-Ser,
[N-Glucitol variant of SEQ ID NO.: 1]
N-Glucitol-Tyr-Ala-Glu-Gly-Thr-Phe-Ile-Ser,
[N-Palmitate variant of SEQ ID NO.: 1]
N-Palmitate-Tyr-Ala-Glu-Gly-Thr-Phe-Ile-Ser,
[N-Fmoc variant of SEQ ID NO.: 1]
N-Fmoc-Tyr-Ala-Glu-Gly-Thr-Phe-Ile-Ser,
[N-alkyl variant of SEQ ID NO.: 1]
N-alkyl-Tyr-Ala-Glu-Gly-Thr-Phe-Ile-Ser,
[N-glycosyl variant of SEQ ID NO.: 1]
N-glycosyl-Tyr-Ala-Glu-Gly-Thr-Phe-Ile-Ser,
[N-isopropyl variant of SEQ ID NO.: 1]
N-isopropyl-Tyr-Ala-Glu-Gly-Thr-Phe-Ile-Ser,
[SEQ ID NO.: 79]
Tyr-Gly-Glu-Gly-Thr-Phe-Ile-Ser,
[SEQ ID NO.: 5]
Tyr-Ser-Glu-Gly-Thr-Phe-Ile-Ser,
[SEQ ID NO.: 80]
Tyr-D-Ala-Glu-Gly-Thr-Phe-Ile-Ser,
[SEQ ID NO.: 81]
Tyr-Abu-Glu-Gly-Thr-Phe-Ile-Ser (note that Abu
means 2-Aminobutylic acid, this also applies to
the following.),
[SEQ ID NO.: 82]
Tyr-Aib-Glu-Gly-Thr-Phe-Ile-Ser,
[SEQ ID NO.: 83]
Tyr-Phosphoserine-Glu-Gly-Thr-Phe-Ile-Ser,
[SEQ ID NO.: 84]
Tyr-Sar-Glu-Gly-Thr-Phe-Ile-Ser,
[SEQ ID NO.: 85]
Tyr-Ala-Pro-Gly-Thr-Phe-Ile-Ser,
[SEQ ID NO.: 86]
Tyr-Ala-Hyp-Gly-Thr-Phe-Ile-Ser,
[SEQ ID NO.: 87]
Tyr-Ala-Lys-Gly-Thr-Phe-Ile-Ser,
[SEQ ID NO.: 88]
Tyr-Ala-Tyr-Gly-Thr-Phe-Ile-Ser,
[SEQ ID NO.: 89]
Tyr-Ala-Phe-Gly-Thr-Phe-Ile-Ser,
[SEQ ID NO.: 2]
Tyr-Ala-Glu-Gly-Thr-Phe-Ile-Ser-Asp,
[N-Acetyl variant of SEQ ID NO.: 2]
N-Acetyl-Tyr-Ala-Glu-Gly-Thr-Phe-Ile-Ser-Asp,
[N-Pyroglutamyl variant of SEQ ID NO.: 2]
N-Pyroglutamyl-Tyr-Ala-Glu-Gly-Thr-Phe-Ile-Ser-
Asp,
[N-Glucitol variant of SEQ ID NO.: 2]
N-Glucitol-Tyr-Ala-Glu-Gly-Thr-Phe-Ile-Ser-Asp,
[N-Palmitate variant of SEQ ID NO.: 2]
N-Palmitate-Tyr-Ala-Glu-Gly-Thr-Phe-Ile-Ser-Asp,
[N-Fmoc variant of SEQ ID NO.: 2]
N-Fmoc-Tyr-Ala-Glu-Gly-Thr-Phe-Ile-Ser-Asp,
[N-alkyl variant of SEQ ID NO.: 2]
N-alkyl-Tyr-Ala-Glu-Gly-Thr-Phe-Ile-Ser-Asp,
[N-glycosyl variant of SEQ ID NO.: 2]
N-glycosyl-Tyr-Ala-Glu-Gly-Thr-Phe-Ile-Ser-Asp,
[N-isopropyl variant of SEQ ID NO.: 2]
N-isopropyl-Tyr-Ala-Glu-Gly-Thr-Phe-Ile-Ser-Asp,
[SEQ ID NO.: 4]
Glu-Gly-Thr-Phe-Ile-Ser-Asp,
[SEQ ID NO.: 90]
Tyr-Gly-Glu-Gly-Thr-Phe-Ile-Ser-Asp,
[SEQ ID NO.: 91]
Tyr-Ser-Glu-Gly-Thr-Phe-Ile-Ser-Asp,
[SEQ ID NO.: 92]
Tyr-D-Ala-Glu-Gly-Thr-Phe-Ile-Ser-Asp,
[SEQ ID NO.: 93]
Tyr-Abu-Glu-Gly-Thr-Phe-Ile-Ser-Asp,
[SEQ ID NO.: 94]
Tyr-Aib-Glu-Gly-Thr-Phe-Ile-Ser-Asp,
[SEQ ID NO.: 95]
Tyr-Phosphoserine-Glu-Gly-Thr-Phe-Ile-Ser-Asp,
[SEQ ID NO.: 96]
Tyr-Sar-Glu-Gly-Thr-Phe-Ile-Ser-Asp,
[SEQ ID NO.: 97]
Tyr-Ala-Pro-Gly-Thr-Phe-Ile-Ser-Asp,
[SEQ ID NO.: 98]
Tyr-Ala-Hyp-Gly-Thr-Phe-Ile-Ser-Asp,
[SEQ ID NO.: 99]
Tyr-Ala-Lys-Gly-Thr-Phe-Ile-Ser-Asp,
[SEQ ID NO.: 100]
Tyr-Ala-Tyr-Gly-Thr-Phe-Ile-Ser-Asp,
[SEQ ID NO.: 101]
Tyr-Ala-Phe-Gly-Thr-Phe-Ile-Ser-Asp

Peptide fragments of the N-terminal end of GLP-1 or analogs thereof can be expressed by the following formula.

[SEQ ID NO.: 102]
Formula: His-X₈-X₉-Gly-Thr-Phe-Thr-Ser-X₁₅

[wherein:
X₈ means Ala, Gly, Ser, Thr, Leu, Ile, Val, Glu, Lys, or Aib,
X₉ means Glu, Gly, or Lys, and
X₁₅ means Asp or omitted.]

Specific examples of peptide fragments of the N-terminal end of GLP-1 or analogs thereof are as follows. Those, in which the two amino acid residues on the N-terminal side of the following peptide fragments on the N-terminal GLP-1 or analogs thereof have been deleted, are inactive peptide fragments.

[SEQ ID NO.: 6]
His-Ala-Glu-Gly-Thr-Phe-Thr-Ser,
[SEQ ID NO.: 10]
His-Ser-Glu-Gly-Thr-Phe-Thr-Ser,
[SEQ ID NO.: 103]
His-Gly-Glu-Gly-Thr-Phe-Thr-Ser,
[SEQ ID NO.: 104]
His-Val-Glu-Gly-Thr-Phe-Thr-Ser,
[SEQ ID NO.: 105]
His-Aib-Glu-Gly-Thr-Phe-Thr-Ser,
[SEQ ID NO.: 7]
His-Ala-Glu-Gly-Thr-Phe-Thr-Ser-Asp,
[SEQ ID NO.: 106]
His-Ser-Glu-Gly-Thr-Phe-Thr-Ser-Asp,
[SEQ ID NO.: 107]
His-Gly-Glu-Gly-Thr-Phe-Thr-Ser-Asp,
[SEQ ID NO.: 108]
His-Val-Glu-Gly-Thr-Phe-Thr-Ser-Asp,
[SEQ ID NO.: 109]
His-Aib-Glu-Gly-Thr-Phe-Thr-Ser-Asp

Specific examples of peptide fragments of the N-terminal end of GLP-2 are as follows. Those, in which the two amino acid residues on the N-terminal side of the following peptide fragments on the N-terminal GLP-2 have been deleted, are inactive peptide fragments.

[SEQ ID NO.: 110]
His-Ala-Asp-Gly-Ser-Phe-Ser,
[SEQ ID NO.: 111]
His-Ala-Asp-Gly-Ser-Phe-Ser-Asp

Specific examples of peptide fragments of the N-terminal end of glucagon are as follows.

[SEQ ID NO.: 11]
His-Ser-Gln-Gly-Thr-Phe-Thr-Ser,
[SEQ ID NO.: 12]
His-Ser-Gln-Gly-Thr-Phe-Thr-Ser-Asp

Before the analysis step using a mass spectrometer, it is preferred that peptide fragments of the glucagon-secretin family peptides in the sample are subjected to a treatment to remove interfering substances such as proteins, peptides and low molecular weight in vivo substances which exist in large numbers in the sample. Quantitative determination sensitivity or precision in the analysis step can be further increased by this treatment. Treatment to remove these interfering substances can be suitably carried out by those of skill in the art by using one or two or more means in combination, such as concentration, dissolving in different solvents, extraction, crystallization, centrifugation and purification. Treatment to remove interfering substances can be carried out either before or after the cleavage step or both before and after.

Examples of extraction methods as a treatment to remove the above interfering substances can include solid-phase extraction and the like. Solid-phase extraction can be carried out using well-known methods; for example, glucagon-secretin family peptides are retained on a solid phase, and then the glucagon-secretin family peptides retained on the solid phase are eluted using an elution solvent. In addition, one or two or more solid phases can be used in combination. As a preferred combination of solid phases, solid phases with different properties are used, for example, a combination of an ion exchange type of solid phase extraction tool and a reversed phase type of solid phase extraction tool. By doing this, a wide variety of interfering substances can be effectively removed. An anion exchange type of solid phase extraction tool or a cation exchange type of solid phase extraction tool can be used, and can be suitably selected by those of skill in the art in accordance with the type(s) of glucagon-secretin family peptides. In a solid phase extraction method, a commercially available cartridge or mini column or a 96-well solid phase extraction plate or the like, into which the above-mentioned solid phase is filled, can be used. The concentration procedure can be carried out by e.g. vacuum concentration, etc.

Purification, which is carried out as a treatment to remove the above interfering substances, can be carried out using liquid chromatography and the like. In liquid chromatography, two phases, a mobile phase and a stationary phase, are involved. In reversed phase chromatography, for example, a water-acetonitrile mixed liquid as the mobile phase and a stationary phase, in which an octadecylsilyl group (C18) is bound to a silica gel support, are used, and separation from other components is carried out due to differences in polarity between the two and the interaction of the polarity of the peptide to be measured. Interfering substances and the peptide to be measured can be separated by reversed phase chromatography or ion exchange chromatography, or a combination thereof utilizing the water-solubility and isoelectric point of the peptide. Especially when a column switching method is used, interfering substances can be efficiently removed using several types of solid phases. Other purification methods can include size exclusion chromatography, electrophoresis and the like. In the present method, purification by liquid chromatography is essential, and one or two or more other purifications can be combined therewith. As liquid chromatography, HPLC, UPLC, UHPLC, nanoflow-LC and the like are known. When a sample comprising peptide fragments obtained in the above-mentioned cleavage step is separated and purified by liquid chromatography, the column is heated (preferably 40 to 60° C.), and methanol comprising 0.1% formic acid can be used as the mobile phase. However, the above-mentioned conditions vary depending on the samples to be treated, and are not limited. The flow rate of the liquid chromatography is preferably 50 nL/min to 50 μL/min, and more preferably 100 nL/min to 1 μL/min. When the flow rate is low, very fine charged droplets can be produced by electrospray ionization, and desolvation can be carried out with high efficiency. The inner diameter of the column used for liquid chromatography is preferably 50 μm or more and less than 1 mm, and more preferably 50 μm or more and 800 μm or less. When a column with a small inner diameter is used, diffusion of peptide fragments to be measured in the column can be prevented, and an improvement in measurement sensitivity can be achieved.

The peptide fragment(s) separated and eluted by liquid chromatography is (are) measured by a mass spectrometer. In mass spectrometry, a substance to be measured is first ionized by any means; the mass-to-charge ratio (m/z) of these ions and the ion amount of this mass are measured. Accordingly, there exist various combinations of ionization and ion measurement in mass spectrometers. For example, mass spectrometers having various functions are known, such as mass spectrometers using the electrospray ionization (ESI) method or the atmospheric pressure chemical ionization (APCI) method, mass spectrometers connected to liquid chromatography (LC/MS, LC/MS/MS, LC/MS/MS/MS etc.), mass spectrometers in which two or more mass spectrometers are connected (MS/MS, MS/MS/MS etc.), tandem mass spectrometers (tandem MS), triple-quadrupole mass spectrometers in which a collision cell is provided between two transmission quadrupole mass spectrometers placed in series (LC/MS/MS etc.), mass spectrometers utilizing an ion trap function (MS/MS/MS etc.), or quadrupole time-of-flight mass spectrometers. In LC/MS/MS, a specific precursor ion to the peptide to be quantitated is selected, e.g. argon is then collided therewith to dissociate the ion, and a new ion group is generated. One or more ions from this new ion group (product ion) are analyzed by the mass spectrometer (MS). Therefore, quantitative determination can be carried out with high specificity. In MS/MS/MS, which has been developed in recent years, the establishment of a quantitative method with higher specificity is required. In MS/MS/MS, measurement can be carried out by setting a primary product ion generated from a precursor ion and further a secondary product ion generated from the primary product ion, and thus, it is advantageous for the measurement in a system in which similar amino acid sequences coexist. The precursor ion is an ion generated by the above-mentioned electrospray ionization, atmospheric pressure chemical ionization and the like, and is a precursor ion of a production.

In an embodiment of the present invention, the separation step and the analysis step can be carried out using a method in which liquid chromatography and mass spectrometry are combined. Specific examples of such methods include liquid chromatography/tandem mass spectrometry (LC/MS/MS, LS/MS/MS/MS etc.), liquid chromatography/mass spectrometry (LC/MS) method and the like. It is preferred that nanoFlow LC-MS/MS/MS be used, in which a triple-quadrupole mass spectrometer with an ion trap function is connected to liquid chromatography, but it is not restricted in the present invention.

A mass spectrum is obtained by mass spectroscopy of the peptide fragments, and is a spectrum in which the m/z is indicated along the abscissa and the detected intensity is indicated along the ordinate. The m/z is a value obtained by dividing the ion mass by the unified atomic mass unit and further dividing the obtained value by the charge number of the ion. By inputting into the mass spectrometer the m/z that is specific to the substance to be measured, it can selectively guide only ions having this m/z into the detector, and thus, the analysis can be carried out with high specificity. Examples of peptide fragments of glucagon-secretin family peptides are shown in Table 1. As is the case with other glucagon-secretin family peptides, a specific m/z of a precursor ion can be set using methods well known to those of skill in the art. When MS/MS or MS/MS/MS is used, quantitative determination can be carried out with high specificity by setting the m/z of 1 to 5 fragment ions and preferably 1 to 3 fragment ions in the same manner.

TABLE 1

| SEQ ID NO. | Abbreviated name | Amino acid sequence | Precursor ion m/z |
|---|---|---|---|
| 1 | GIP₁₋₈ | Tyr-Ala-Glu-Gly-Thr-Phe-Ile-Ser | 887.4 ± 0.50 |
| 2 | GIP₁₋₉ | Tyr-Ala-Glu-Gly-Thr-Phe-Ile-Ser-Asp | 1002.4 ± 0.50 |
| 3 | GIP₃₋₈ | Glu-Gly-Thr-Phe-Ile-Ser | 653.3 ± 0.50 |
| 4 | GIP₃₋₉ | Glu-Gly-Thr-Phe-Ile-Ser-Asp | 768.3 ± 0.50 |
| 5 | 2S-GIP₁₋₈ | Tyr-Ser-Glu-Gly-Thr-Phe-Ile-Ser | 903.4 ± 0.50 |
| 6 | GLP-1 (7-14) | His-Ala-Glu-Gly-Thr-Phe-Thr-Ser | 849.4 ± 0.50 or 425.2 ± 0.50 |
| 7 | GLP-1 (7-15) | His-Ala-Glu-Gly-Thr-Phe-Thr-Ser-Asp | 964.4 ± 0.50 or 482.7 ± 0.50 |
| 8 | GLP-1 (9-14) | Glu-Gly-Thr-Phe-Thr-Ser | 641.3 ± 0.50 or 321.1 ± 0.50 |
| 9 | GLP-1 (9-15) | Glu-Gly-Thr-Phe-Thr-Ser-Asp | 756.3 ± 0.50 or 378.7 ± 0.50 |
| 10 | 8S-GLP-1 (7-14) | His-Ser-Glu-Gly-Thr-Phe-Thr-Ser | 865.4 ± 0.50 or 433.2 ± 0.50 |
| 11 | Glucagon₁₋₈ | His-Ser-Gln-Gly-Thr-Phe-Thr-Ser | 864.4 ± 0.50 or 432.7 ± 0.50 |
| 12 | Glucagon₁₋₉ | His-Ser-Gln-Gly-Thr-Phe-Thr-Ser-Asp | 979.4 ± 0.50 or 490.2 ± 0.50 |

In another embodiment of the present invention, glucagon-secretin family peptides or analogs thereof in a sample are quantitated using a calibration curve. Using standard solutions diluted in stages, a peptide fragment derived from a standard is measured by a mass spectrometer, and a calibration curve can be made by one skilled in the art according to typical methods. It is preferred that, in the calibration curve, the accuracy is within ±20% at the lower limit of the quantification and is within ±15% at other concentrations, and the correlation coefficient is 0.990 or more. In case the quantitative determination is carried out using a calibration curve, the following are used, e.g.: (a) an absolute calibration method, in which a prescribed amount of standard is injected and the quantitative determination is made based upon a detected peak area, (b) an internal standard method, in which a standard (an internal standard) different from the measured sample is added and the quantitative determination is made based upon a detected peak area ratio of the two. It is preferred that a calibration curve is made using the internal standard method to increase quantitative determination precision. In case the internal standard is used, for example, a ratio between the area peak of the glucagon-secretin family peptide in the sample and the area peak of the internal standard is calculated, and a calibration curve with high reliability can be made by plotting this ratio on a graph. In addition, by using standard solutions prepared by dissolving a standard, human endogenous glucagon-secretin family peptides in a sample can be measured, and quantitative determination can be carried out even in a concentration range of not more than a standard concentration. The lower limit of quantification is the weakest concentration of the standard concentration in the sample, from among the samples in which the standard used to make the calibration curve has been added, and means that the above-mentioned accuracy is within ±20%. The accuracy of the calibration curve is calculated by dividing a value obtained by subtracting an addition concentration from a quantitative value by the addition concentration. The above-mentioned correlation coefficient can be calculated by using spreadsheet software. Using the generated calibration curve, the glucagon-secretin family peptide(s) in the sample can be quantitated.

As an internal standard, for example, preferred is one in which one or more amino acids of the glucagon-secretin family peptide to be measured are substituted with (a) stable isotope-labeled amino acid(s). Any amino acid selected from positions 1-15 of the amino acids to be measured is further preferably substituted with a stable isotope-labeled amino acid. In case a stable isotope-labeled peptide is used, for example, the internal standard can be obtained by e.g. labeling Phe with a stable isotope. Phe frequently exists at any of positions 1-15 of glucagon-secretin family peptides. Phe, for example, exists at position 6 of GIP₁₋₄₂, position 12 of GLP-1 (7-36), position 6 of GLP-2 and position 6 of glucagon. Phe is an amino acid suitable for stable isotope labeling, and can cause a difference of 10 Da or more from the original peptide to be measured; thus, cross-talk during the quantitative determination by mass spectrometry can be minimized. Further, e.g. Leu, Ile, Val, Ala, Tyr, Glu, Gly, Thr, Ser and Pro are amino acids suitable for stable isotope labeling. Stable isotopes include ²H, ¹³C, ¹⁵N, ¹⁸O and the like, and these isotopes can be used individually, or two or more isotopes can be used in combination. Further, there are a method in which ¹⁸O is introduced by hydrolase cleavage in H₂¹⁸O, a method in which stable isotope labeling is carried out using e.g. a commercially-available stable isotope-labeled reagent, and the like. A stable isotope-labeled peptide is chemically identical with a non-labeled peptide except that the mass of the peptide to be quantitated and the mass of the labeled amino acid are different, and both peptides exhibit identical behaviors in the LC-MS/MS measurement; therefore, influences caused by the ionization of impurities can be excluded, and the stable isotope-labeled peptide can be advantageously used as an internal standard peptide. In all methods, the substance to be measured and the internal standard have a difference of mass, and thus are detected as different peaks by e.g. LC/MS; quantitative determination can be carried out based on the area or height ratio of the two peaks.

The stable isotope-labeled internal standard can be the entire amino acid sequence of a glucagon-secretin family peptide, or can be a peptide fragment to be measured. An internal standard, in which part of the entire amino acid sequence is labeled, is preferred to increase the accuracy of the quantitative values. Supposing that an internal standard is used in which part of a peptide fragment to be measured is labeled, extraction efficiency in pretreatment up to the cleavage step will not be always the same as that of a glucagon-secretin family peptide to be quantitated. In addition, digestion efficiency using site-specific proteases or acids is not always the same as that of the glucagon-secretin family peptide to be quantitated. Such extraction efficiency and digestion efficiency vary in each sample, and thus, it is difficult to completely correct a glucagon-secretin family peptide to be quantitated using an internal standard in which part of a peptide fragment to be measured is labeled. Accordingly, when part of the entire amino acid sequence is labeled and added to a sample, the amount of glucagon-secretin family peptide can be corrected in the entire process of pretreatment, and thus, the accuracy of the quantitative values can be increased. As the internal standard, not only stable isotope-labeled peptides can be used, but also peptides, in which one or more amino acids of the peptide fragment to be measured are altered, or peptides, in which the order of the amino acid sequence of the peptide fragment to be measured is changed.

An embodiment of the present invention comprises a kit for quantitating glucagon-secretin family peptides or analogs thereof in a sample. This kit comprises (a) a matrix for control, (b) an internal standard or a solution thereof, (c) glucagon-secretin family peptides or solutions thereof, (d) a cleaving agent and (e) a solid phase extraction plate. The above cleaving agent (d) is as described in paragraph 24, and any one selected from the group consisting of endopeptidase ASP-N, formic acid, acetic acid, trifluoroacetic acid, propionic acid and combinations thereof is preferred. A buffer for treating the cleaving agent can be added to the kit as needed. A method for using this kit will be described below. Firstly, a matrix for control (a), an internal standard or a solution (b) thereof are added to a sample, and for a calibration curve, glucagon-secretin family peptides or solutions thereof (c) are further added in prescribed amounts. After that, peptide fragments are obtained using a cleaving agent (d), and then the extraction procedure is carried out using a solid phase extraction plate (e). Peptide fragments of a calibration curve and in an extraction sample obtained from the sample are measured; by fitting to the calibration curve the ratio between the area peak of the glucagon-secretin family peptide obtained from the sample and the area peak of the internal standard, the glucagon-secretin family peptides in the sample can be quantitated.

### EXAMPLES

The present invention will be described in more detail by way of the following examples. It should be noted, however, that the present invention is not restricted thereto, and changes can be made without departing from the scope of the present invention.

Test 1 Comparison of measuring methods for glucagon-secretin family peptides

### Method

The stabilities of to-be-measured peptide fragments of GIP, a glucagon-secretin family peptide, were compared. To the following peptide fragments (a) and (b) synthesized by solid phase synthesis, 0.1% TFA-20% acetonitrile was added to obtain a 2.0 μM solution. This solution was measured by LC/MS/MS (Applied Biosystems: QSTAR (registered trademark) Elite). The measurement was carried out immediately after preparation and at 17 days after preparation.
(a) GIP₁₋₈: GIP₁₋₈ was used, in which aspartic acid at position 9 of GIP₁₋₄₂ was cleaved on the N-terminal side. The amino acid sequence of GIP₁₋₈ is Tyr-Ala-Glu-Gly-Thr-Phe-Ile-Ser [SEQ ID NO.: 1].
(b) GIP₁₋₁₆: GIP₁₋₁₆ was used, in which lysine at position 16 of GIP₁₋₄₂ was cleaved on the C-terminal side. When GIP₁₋₄₂ is cleaved by trypsin, lysine at position 16 is cleaved on the C-terminal side. The amino acid sequence of GIP₁₋₁₆ is Tyr-Ala-Glu-Gly-Thr-Phe-Ile-Ser-Asp-Tyr-Ser-Ile-Ala-Met-Asp-Lys [SEQ ID NO.: 112].

Results

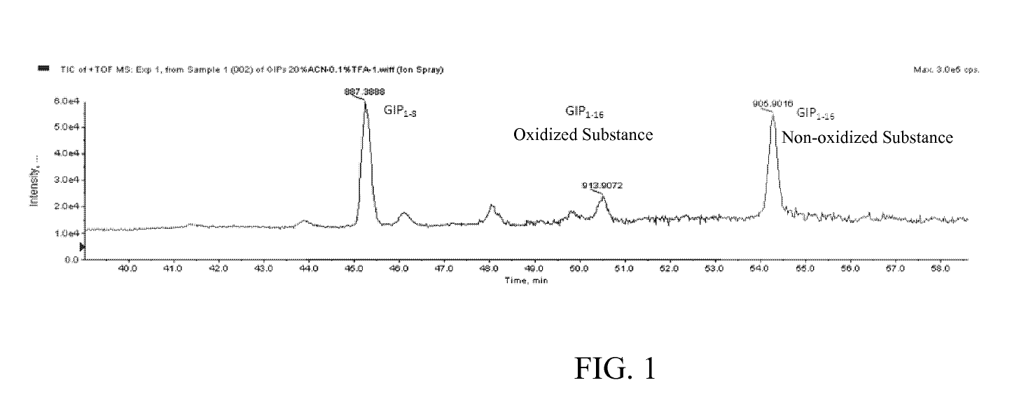

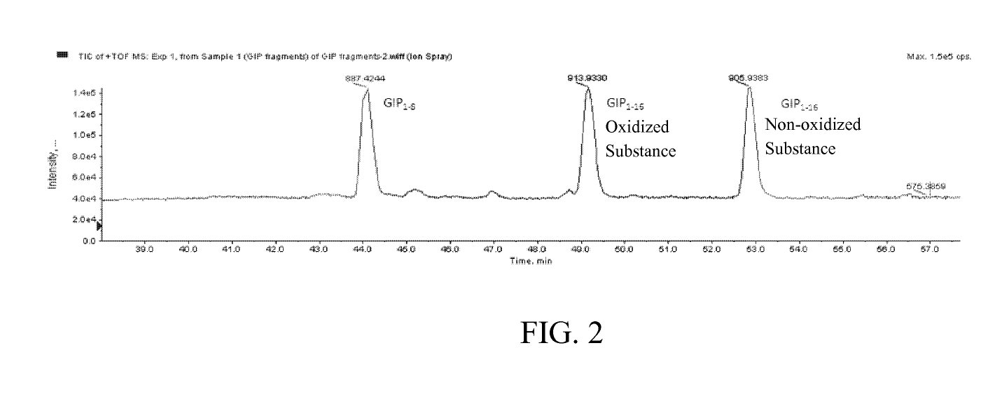

The measured values immediately after preparation are shown in FIG. 1, and the measured values at 17 days after preparation are shown in FIG. 2.

For GIP₁₋₈, one peak was observed (m/z 887.4 ([M+H]⁺)). For GIP₁₋₁₆, two peaks were observed (m/z 905.9 ([M+2H]²⁺) and m/z 913.9 ([M+2H]²⁺)). One of the peaks observed in GIP₁₋₁₆ enlarged with time after refrigerated storage, and the peak intensity ratio between that peak and the other peak was almost 1:1 at 17 days after preparation. The peak that changed over time was the peak of an oxidized substance, in which methionine (Met) of GIP₁₋₁₆ was oxidized. The peak enlarges over time, which shows that the molecular weight of the peptide changes over time and the concentration in the sample cannot be accurately measured. The peptide fragment of GIP₁₋₈ was more stable than the peptide fragment of GIP₁₋₁₆.

### Example 1

### Measuring Method for GIP Analogs

### Method

An embodiment for measuring a GIP analog (2S-GIP-NH₂) [the C-terminus amide derivative of SEQ ID NO.: 113], a glucagon-secretin family peptide, is shown. This GIP analog is a GIP analog in which alanine at position 2 of the active GIP is substituted with serine and the C-terminus thereof is amidated. As the cleaving agent, ASP-N was used. This GIP analog was dissolved with 50 mM Tris/HCl and a 2.5 mM ZnSO₄ solution (pH 8.0). To this solution, 1 μg of Asp-N was added, and the solution was incubated at 37° C. for 15 hours to cleave this GIP analog. After that, the sample was analyzed by LC/MS (LCQ Deca XP Plus).

### Results

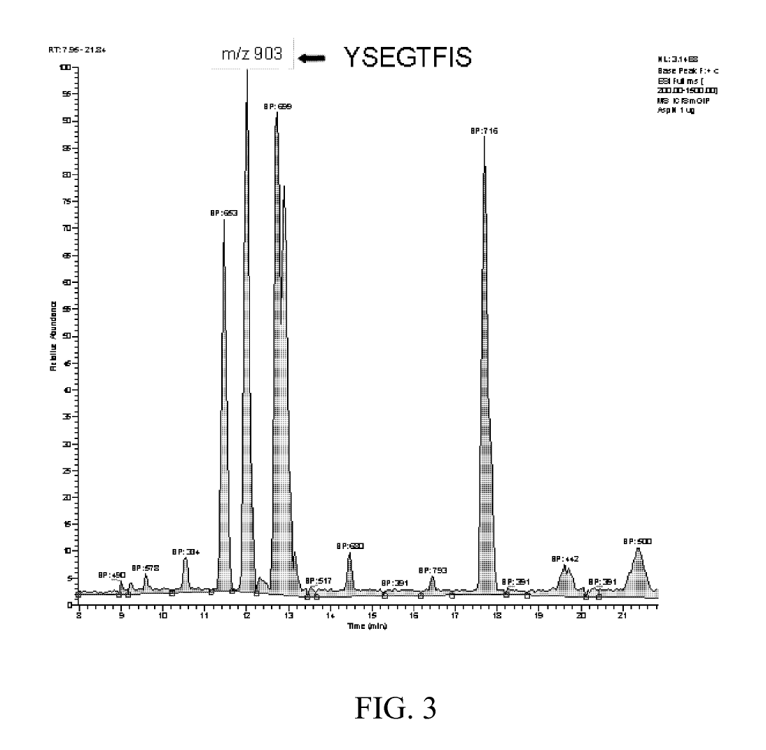

The results, in which the GIP analog was cleaved by Asp-N and analyzed, are shown in FIG. 3. One peak (m/z 903 ([M+H]⁺)) was observed. This peak was 25-GIP₁₋₈ in which the N-terminal side of aspartic acid at position 9 of the active GIP analog was cleaved.

[SEQ ID NO.: 5]
2S-GIP₁₋₈: Tyr-Ser-Glu-Gly-Thr-Phe-Ile-Ser

### Example 2

### Measuring Method for GIP

### Method

An embodiment for measuring active GIP [SEQ ID NO.: 13], a glucagon-secretin family peptide, is shown. As the cleaving agent, formic acid was used. Active GIP₁₋₄₂ was dissolved with purified water to obtain a 100 μM solution. To 50 μL of this solution, 500 μL of 2% formic acid was added, and the solution was incubated at 108° C. for 18 hours and the cleavage of active GIP₁₋₄₂ was confirmed with time. After that, each sample was analyzed by LC/MS (LCQ Deca XP Plus).

### Results

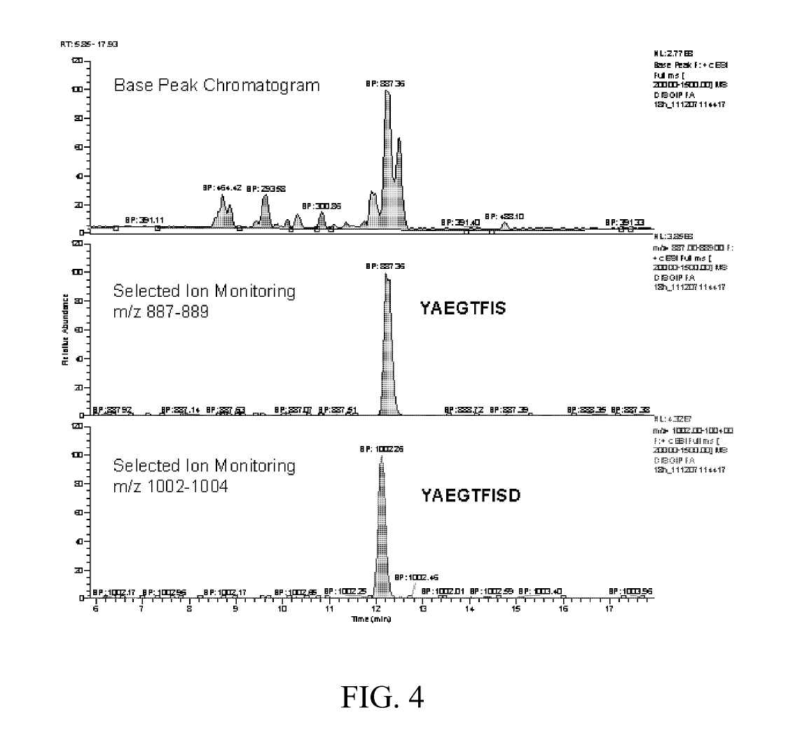

The results, in which the active GIP₁₋₄₂ was cleaved by formic acid and analyzed, are shown in FIG. 4. Peaks of m/z 887 ([M+H]⁺) and m/z 1002 ([M+H]⁺) were observed. These two peaks were GIP₁₋₈, in which the N-terminal side of aspartic acid at position 9 of the active GIP₁₋₄₂ was cleaved, and GIP₁₋₉, in which the C-terminal side of aspartic acid at position 9 of the active GIP₁₋₄₂ was cleaved.

[SEQ ID NO.: 1]
GIP₁₋₈: Tyr-Ala-Glu-Gly-Thr-Phe-Ile-Ser
[SEQ ID NO.: 2]
GIP₁₋₉: Tyr-Ala-Glu-Gly-Thr-Phe-Ile-Ser-Asp

### Example 3

### Measuring Method for GIP

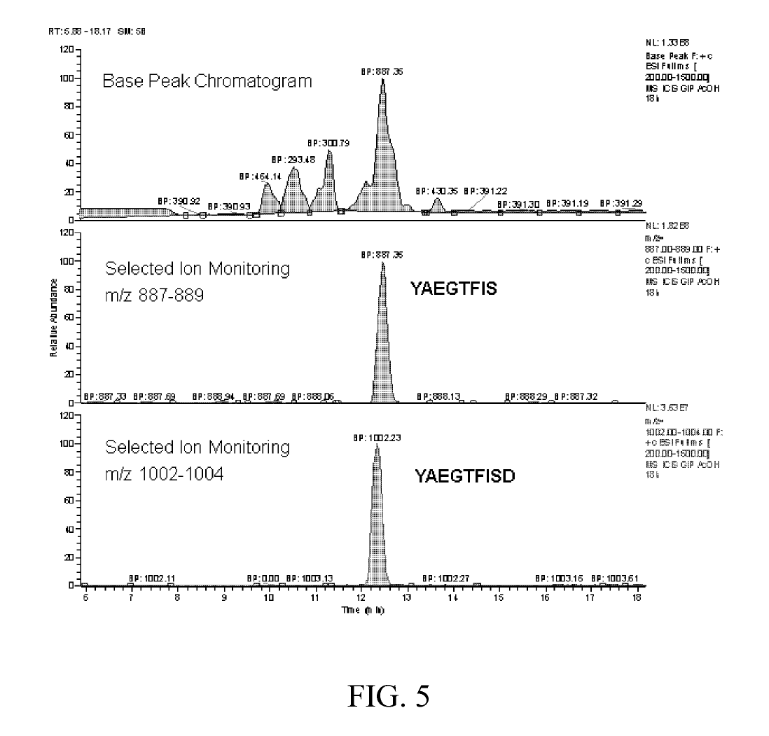

Another embodiment for measuring active GIP [SEQ ID NO.: 13], a glucagon-secretin family peptide, is shown. As the cleaving agent, acetic acid was used. The analysis was carried out according to the same method as in Example 2 except that 500 μL of 2% acetic acid was added instead of 500 μL of 2% formic acid. The analysis results are shown in FIG. 5. Peaks of GIP₁₋₈ [SEQ ID NO.: 1], in which the N-terminal side of aspartic acid at position 9 of the active GIP₁₋₄₂ was cleaved, and GIP₁₋₉ [SEQ ID NO.: 2], in which the C-terminal side of aspartic acid at position 9 of the active GIP₁₋₄₂ was cleaved, were observed.

### Example 4

### Measuring Method for GIP

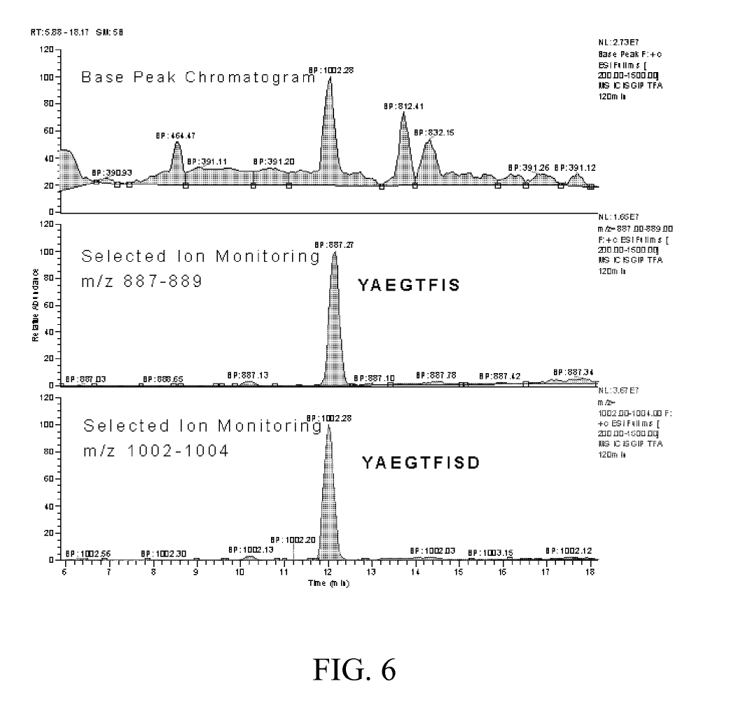

Another embodiment for measuring active GIP [SEQ ID NO.: 13], a glucagon-secretin family peptide, is shown. As the cleaving agent, trifluoroacetic acid was used. The analysis was carried out according to the same method as in Example 2 except that 500 μL of 1% trifluoroacetic acid was added instead of 500 μL of 2% formic acid. The analysis results are shown in FIG. 6. Peaks of GIP₁₋₈ [SEQ ID NO.: 1], in which the N-terminal side of aspartic acid at position 9 of the active GIP₁₋₄₂ was cleaved, and GIP₁₋₉ [SEQ ID NO.: 2], in which the C-terminal side of aspartic acid at position 9 of the active GIP₁₋₄₂ was cleaved, were observed.

### Example 5

### Measuring Method for GLP-1

### Method

An embodiment for measuring GLP-1 (7-36) [SEQ ID NO.: 25], a glucagon-secretin family peptide, is shown. As the cleaving agent, ASP-N was used. The analysis was carried out according to the same method as in Example 1 except that GLP-1 (7-36) was used instead of a GIP analog.

### Results

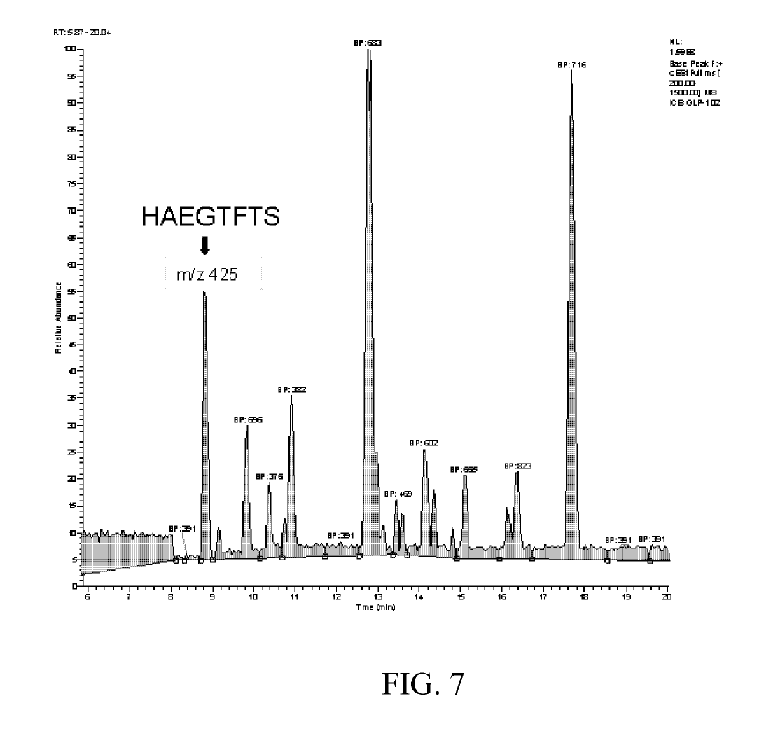

The analysis results are shown in FIG. 7. A peak of GLP-1 (7-14), in which the N-terminal side of aspartic acid at position 15 of GLP-1 (7-36) was cleaved, was observed (m/z 425 ([M+2H]²⁺)).

[SEQ ID NO.: 6]
GLP-1 (7-14): His-Ala-Glu-Gly-Thr-Phe-Thr-Ser

### Example 6

### Measuring Method for Glucagon

### Method

An embodiment for measuring glucagon [SEQ ID NO.: 69], a glucagon-secretin family peptide, is shown. As the cleaving agent, ASP-N was used. The analysis was carried out according to the same method as in Example 1 except that glucagon was used instead of a GIP analog.

### Results

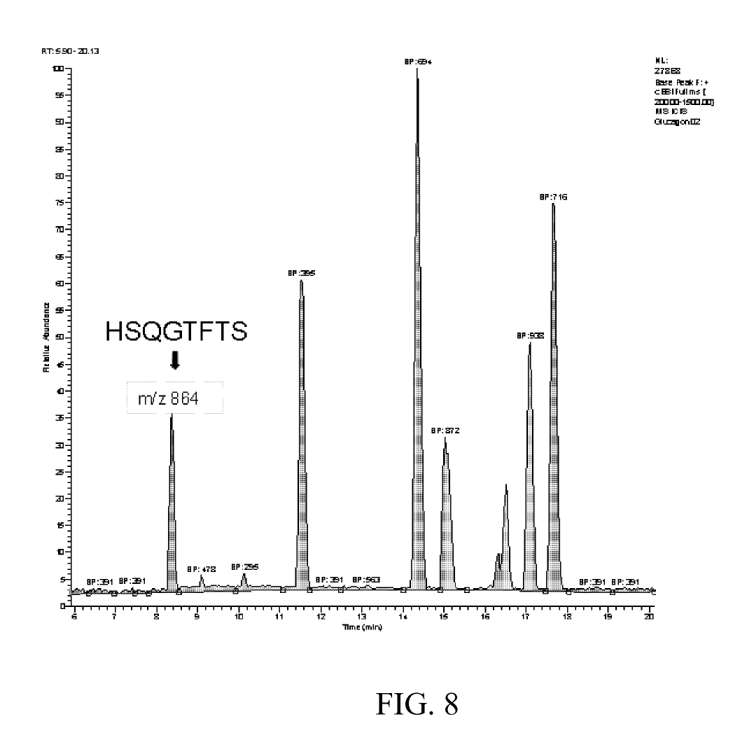

The analysis results are shown in FIG. 8. A peak of glucagon₁₋₈, in which the N-terminal side of aspartic acid at position 9 of glucagon was cleaved, was observed (m/z 864 ([M+H]⁺)).

[SEQ ID NO.: 11]
Glucagon₁₋₈: His-Ser-Gln-Gly-Thr-Phe-Thr-Ser

### Example 7

### Measuring Method for a GLP-1 Analog

### Method

An embodiment for measuring a GLP-1 analog (8S-GLP-1) [SEQ ID NO.: 31], a glucagon-secretin family peptide, is shown. This analog is a GLP-1 analog, in which alanine at position 8 of GLP-1 (7-36) is substituted with serine. As the cleaving agent, ASP-N was used. The analysis was carried out according to the same method as in Example 1 except that 5 nmol of a GLP-1 analog was used instead of 5 nmol of a GIP analog and the amount of Asp-N was changed from 1 μg to 2 μg.

### Results

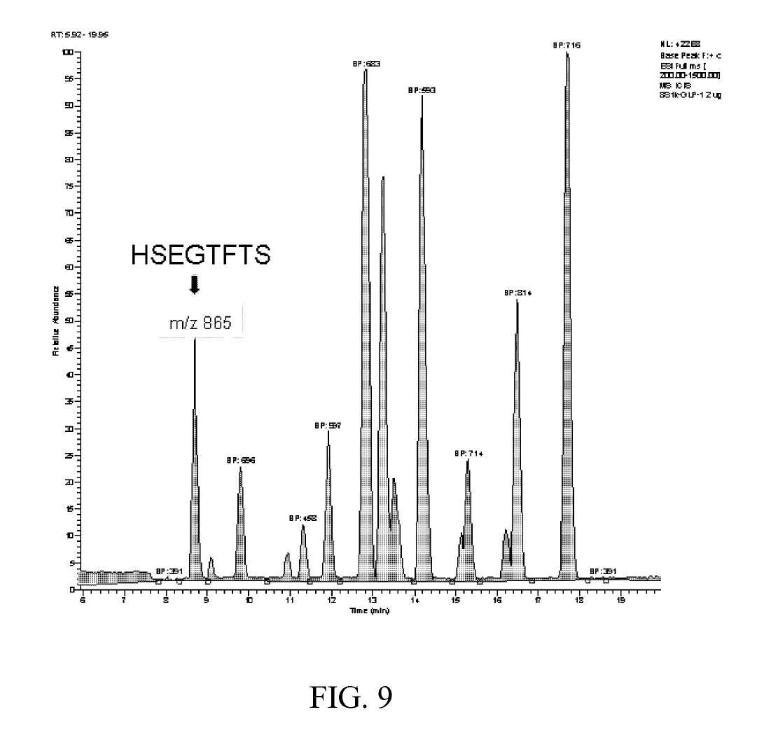

The analysis results are shown in FIG. 9. A peak of 8S-GLP-1 (7-14), in which the N-terminal side of aspartic acid at position 14 of the GLP-1 analog was cleaved, was observed (m/z 865 ([M+H]⁺)).

[SEQ ID NO.: 10]
8S-GLP-1 (7-14): His-Ser-Glu-Gly-Thr-Phe-Thr-Ser

As shown in Examples 1 to 7, by cleaving the peptide bond of any aspartic acid selected from positions 1-14 of glucagon-secretin family peptides, the peptide fragments of the glucagon-secretin family peptides could be satisfactorily analyzed regardless of the type of glucagon-secretin family peptide.

### Example 8

### Quantitative Method for Active GIP

An embodiment for quantitating the concentration of an active GIP [SEQ ID NO.: 13] in a sample using a calibration curve is shown.

### Method

### 1. Preparation of Calibration Curve Samples

As the internal standard, the following internal standard was synthesized, in which Phe at position 6 of GIP was substituted with ¹³C₉, ¹⁵N-Phe, a stable isotope-labeled amino acid. Calibration curve samples were prepared according to the following procedures (1) to (3).

Standard
[SEQ ID NO.: 13]
Tyr-Ala-Glu-Gly-Thr-Phe-Ile-Ser-Asp-Tyr-Ser-Ile-
Ala-Met-Asp-Lys-Ile-His-Gln-Gln-Asp-Phe-Val-Asn-
Trp-Leu-Leu-Ala-Gln-Lys-Gly-Lys-Lys-Asn-Asp-Trp-
Lys-His-Asn-Ile-Thr-Gln
Internal standard
Tyr-Ala-Glu-Gly-Thr-¹³C₉, ¹⁵N-Phe-Ile-Ser-Asp-Tyr-
Ser-Ile-Ala-Met-Asp-Lys-Ile-His-Gln-Gln-Asp-Phe-
Val-Asn-Trp-Leu-Leu-Ala-Gln-Lys-Gly-Lys-Lys-Asn-
Asp-Trp-Lys-His-Asn-Ile-Thr-Gln
(the amino acid sequence is the same as SEQ ID
NO.: 13)

(1) Preparation of standard solutions of active GIP: active GIP₁₋₄₂ (purchased from Peptide Institute, Inc.) was dissolved with purified water to prepare a 100 μM solution. This solution was diluted to prepare standard solutions, each having 20.0 pM, 200 pM, 2.00 nM, 20.0 nM and 1.00 μM.
(2) Preparation of standard solutions of the internal standard: the above-mentioned synthesized internal standard was dissolved to prepare a 100 μM solution. This solution was diluted to prepare standard solutions of the internal standard, each having 2.00 nM, 20.0 nM and 1.00 μM.
(3) Preparation of calibration curve samples: in a 2 mL tube, 2 μL of DPP-4 inhibitor (Diprotin A, 0.3 M) was added, and 200 μL of human EDTA-added plasma treated with activated charcoal, a standard solution of active GIP and a standard solution of the internal standard were added thereto under ice-cold conditions to prepare a calibration curve sample. The percentages, in which the standard solution of the active GIP and the standard solution of the internal standard are added, are shown in Table 2. DPP-4 inhibitor was added to inhibit decomposition of GIP₁₋₄₂ to GIP₃₋₄₂ or decomposition of GIP₁₋₈ to GIP₃₋₈ in the pretreatment process.

TABLE 2

| | | | Concentration of | Addition amount of |
|---|---|---|---|---|
| Calibration curve | Concentration of | Addition amount of | standard solution of | standard solution of |
| concentration | standard solution of | standard solution of | internal standard | internal standard |
| (pM Plasma) | GIP (pM) | GIP (μL) | substance (pM) | substance (μL) |
| 1 | 20 | 10 | 2000 | 10 |
| 2 | 20 | 20 | 2000 | 10 |
| 5 | 20 | 50 | 2000 | 10 |
| 10 | 200 | 10 | 2000 | 10 |
| 20 | 200 | 20 | 2000 | 10 |
| 50 | 200 | 50 | 2000 | 10 |
| 100 | 2000 | 10 | 2000 | 10 |
| 200 | 2000 | 20 | 2000 | 10 |
| 500 | 2000 | 50 | 2000 | 10 |

### 2. Pretreatment

### (1) Deproteinization

To the above-mentioned calibration curve sample, 100 μL of a 180 mM solution of ammonium carbonate and 900 μL of ethanol were added, and the obtained mixture was stored on ice for 20 minutes. After centrifugation, the supernatant was concentrated to dryness.

### (2) Cleavage of the Glucagon-Secretin Family Peptide in the Sample

The above calibration curve sample after deproteinization was cleaved by a protease (ASP-N). To the above calibration curve sample after deproteinization, 100 μL of a 50 mM Tris/HCl and 2.5 mM ZnSO₄ solution (pH 8.0) were added, and further 8 μL of a 0.1 mg/mL Asp-N aqueous solution was added, and the obtained mixture was incubated at 37° C. for 16 hours.

### (3) Solid Phase Extraction

Using a solid phase plate (manufactured by Waters; Oasis MAX 96-well μElution Plate), 300 μL of 5% ammonium water was added to the calibration curve sample obtained in the above-mentioned (2), and this was loaded onto the solid phase plate, which was subjected to conditioning. The solid phase plate was washed, followed by elution with 50 μL of 0.1% formic acid-75% acetonitrile. The eluate was transferred to a HPLC vial, and concentrated to dryness using a centrifugal evaporator. Further, it was reconstituted with 20 μL of 0.1% TFA-10% acetonitrile.

(4) Filtration through a Filter

The sample after being reconstituted was subjected to centrifugal filtration using a centrifugal filter unit (0.2 μm) to obtain a HPLC sample.

### 3. Measurement

5 μL of the above HPLC sample subjected to pretreatment was injected into a nanoFlow LC-MS/MS/MS, and peptides derived from the standard and the internal standard contained in the HPLC sample were measured. The measuring conditions are shown in Table 3 and Table 4.

### (1) HPLC Conditions

TABLE 3

| | |
|---|---|
| LC system | Ultimate ™3000 nano-LC system |
| Trap column | C18, 5 μm, 100 Å, 300 μm i.d. × 1 mm |
| Mobile phase for trap column | 0.1% TFA-2% Acetonitrile |
| Flow rate | 25 μL/min |
| Analytical column | C18, 3 μm, 100 Å, 75 μm i.d. × 15 cm |
| Mobile phase A | 0.1% formic acid-2% methanol |
| Mobile phase B | 0.1% formic acid-95% methanol |
| Flow rate | 250 nL/min |

### (2) MS Conditions

TABLE 4

| | |
|---|---|
| Mass spectrometer | QTRAP ® 5500 |
| Ionization method | Nanospray ESI |
| Polarity | Positive |
| Detection mode | MRM3 (Linear ion trap mode) |
| Monitor ion of substance to be | m/z 887.4 → m/z 782.4 → m/z 764.2 |
| measured | |
| Monitor ion of internal standard | m/z 897.4 → m/z 792.4 → m/z 774.2 |
| substance | |

Results

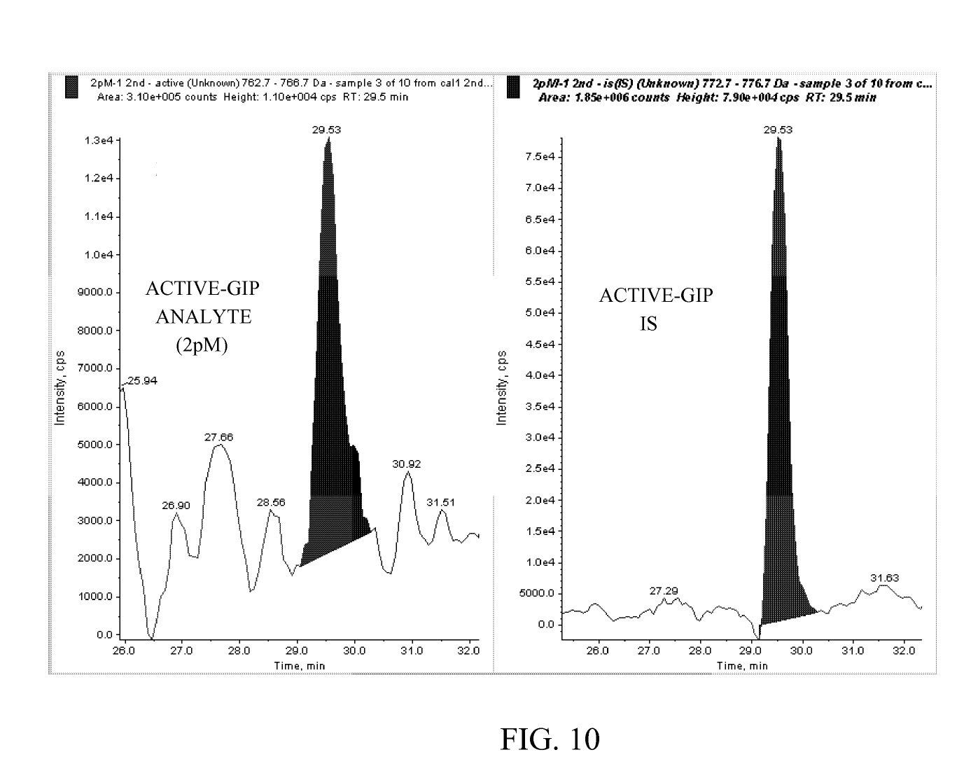

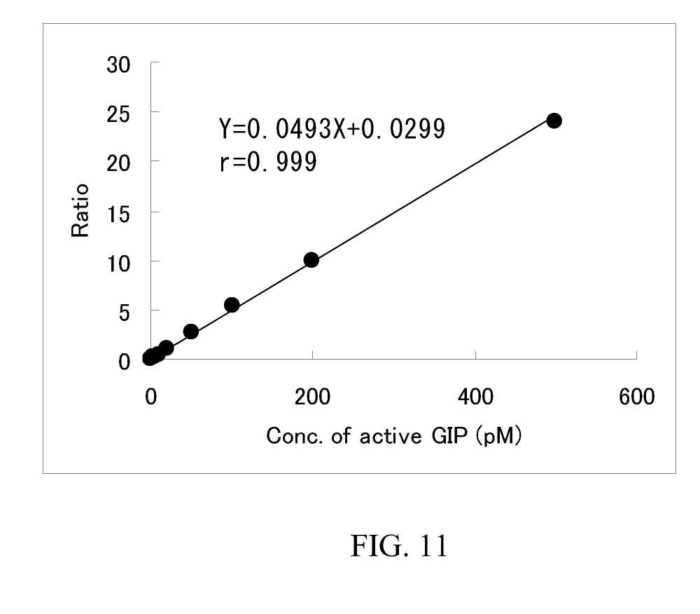

The calibration curve samples were measured, and the peptide fragment derived from active GIP (Tyr-Ala-Glu-Gly-Thr-Phe-Ile-Ser [SEQ ID NO.: 1]) and the peptide fragment derived from the internal standard (Tyr-Ala-Glu-Gly-Thr-¹³C₉, ¹⁵N-Phe-Ile-Ser (the amino acid sequence is the same as SEQ ID NO.: 1)) each could be detected as an individual peak (FIG. 10). The concentration of active GIP and the peak area ratio of the two (the peak area of the peptide derived from the active GIP/the peak area of the peptide derived from the internal standard) were subjected to linear regression analysis using the linear least-squares method to calculate a slope, an intercept and a correlation coefficient (r). A calibration curve was made in the range of 1 pM to 500 pM. Consequently, the correlation coefficient (r) was 0.990 or more and the lower limit of quantification was 1 pM (FIG. 11).

### Example 9

### Simultaneous Reproducibility Test of Active GIP in Human Plasma

### Method

Active GIP in human plasma [SEQ ID NO.: 13] was quantitated in the same manner as in Example 8, and the obtained peak area ratio was fitted to each calibration curve to calculate the concentration of each sample. The accuracy (Bias %) and precision (% CV) of the obtained measured values (n=3) were calculated at each concentration. The criteria were that the accuracy be within ±15% (the lower limit of quantification is within ±20%), and the precision be within 15% (the lower limit of quantification is within 20%).

### Results

The results are shown in Table 5. Active GIP at each concentration satisfied the criteria for simultaneous reproducibility. This shows that the reproducibility of the measured values is good.

TABLE 5

| | Theoretical value (pM) | | | | | | | | |
|---|---|---|---|---|---|---|---|---|---|
| | 1 | 2 | 5 | 10 | 20 | 50 | 100 | 200 | 500 |
| Calibration curve 1 | 0.996 | 2.13 | 4.49 | 8.86 | 20.6 | 52.6 | 109 | 202 | 487 |
| Calibration curve 2 | 0.830 | 1.82 | 4.29 | 11.3 | 22.4 | 54.5 | 108 | 204 | 481 |
| Calibration curve 3 | 0.847 | 2.27 | 5.51 | 8.80 | 20.7 | 51.8 | 92.8 | 208 | 498 |
| Mean (pM) | 0.891 | 2.07 | 4.76 | 9.65 | 21.2 | 53.0 | 103 | 205 | 489 |
| S.D. | 0.091 | 0.23 | 0.65 | 1.43 | 1.0 | 1.4 | 9 | 3 | 9 |
| % CV | 10.3 | 11.1 | 13.7 | 14.8 | 4.8 | 2.6 | 8.8 | 1.5 | 1.8 |
| Bias % | −10.9 | 3.7 | −4.7 | −3.5 | 6.2 | 5.9 | 3.3 | 2.3 | −2.3 |

### Example 10

### Simultaneous Quantitative Method for Active GIP and Inactive GIP

### Method

### 1. Preparation of Calibration Curve Samples

Measurement samples containing a standard and an internal standard were prepared in the same manner as in Example 8. As the internal standard, the following peptide was synthesized and added, in which Phe at position 6 of GIP was substituted with ¹³C₉, ¹⁵N-Phe. An internal standard of the inactive GIP is one in which the two N-terminal residues of the internal standard of the active GIP are deleted.

[Standard of active GIP]
[SEQ ID NO.: 13]
Tyr-Ala-Glu-Gly-Thr-Phe-Ile-Ser-Asp-Tyr-Ser-Ile-
Ala-Met-Asp-Lys-Ile-His-Gln-Gln-Asp-Phe-Val-Asn-
Trp-Leu-Leu-Ala-Gln-Lys-Gly-Lys-Lys-Asn-Asp-Trp-
Lys-His-Asn-Ile-Thr-Gln
[Standard of inactive GIP]
[SEQ ID NO.: 14]
Glu-Gly-Thr-Phe-Ile-Ser-Asp-Tyr-Ser-Ile-Ala-Met-
Asp-Lys-Ile-His-Gln-Gln-Asp-Phe-Val-Asn-Trp-Leu-
Leu-Ala-Gln-Lys-Gly-Lys-Lys-Asn-Asp-Trp-Lys-His-
Asn-Ile-Thr-Gln (GIP₃₋₄₂: )
[Internal standard of active GIP]
Tyr-Ala-Glu-Gly-Thr-¹³C₉, ¹⁵N-Phe-Ile-Ser-Asp-Tyr-
Ser-Ile-Ala-Met-Asp-Lys-Ile-His-Gln-Gln-Asp-Phe-
Val-Asn-Trp-Leu-Leu-Ala-Gln-Lys-Gly-Lys-Lys-Asn-
Asp-Trp-Lys-His-Asn-Ile-Thr-Gln (the amino acid
sequence is the same as SEQ ID NO.: 13)
[Internal standard of inactive GIP]
Glu-Gly-Thr-¹³C₉, ¹⁵N-Phe-Ile-Ser-Asp-Tyr-Ser-Ile-
Ala-Met-Asp-Lys-Ile-His-Gln-Gln-Asp-Phe-Val-Asn-
Trp-Leu-Leu-Ala-Gln-Lys-Gly-Lys-Lys-Asn-Asp-Trp-
Lys-His-Asn-Ile-Thr-Gln (the amino acid sequence
is the same as SEQ ID NO.: 14)

(1) Preparation of standard solutions of active GIP: active GIP (purchased from Peptide Institute, Inc.) was dissolved by adding purified water to obtain a 100 μM solution. This solution was diluted with 50% ethanol to prepare standard solutions, each having 20.0 pM, 200 pM, 2.00 nM, 20.0 nM and 1.00 μM.
(2) Preparation of standard solutions of the internal standard for active GIP: the synthesized internal standard peptide was dissolved to prepare a 100 μM solution. This solution was diluted to prepare standard solutions, each having 1.00 nM, 10.0 nM and 1.00 μM.
(3) Preparation of standard solutions of inactive GIP: purchased inactive GIP was dissolved to prepare a 100 μM solution. This solution was diluted to prepare standard solutions, each having 20.0 pM, 200 pM, 2.00 nM, 20.0 nM and 1.00 μM.
(4) Preparation of standard solutions of the internal standard for inactive GIP: the synthesized internal standard peptide was dissolved with 50% ethanol to prepare a 100 μM solution. This solution was diluted with 50% ethanol to prepare standard solutions, each having 1.00 nM, 10.0 nM and 1.00 μM.
(5) Preparation of calibration curve samples: in 2 mL tube, 2 μL of DPP-4 inhibitor (Diprotin A, 0.3 M) was added, and 200 μL of human EDTA-added plasma treated with activated charcoal, a standard solution of active GIP, and a standard solution of the internal standard for active GIP, as well as a standard solution of inactive GIP, and a standard solution of the internal standard for inactive GIP were added thereto under ice-cold conditions as shown in Table 6 to prepare calibration curve samples.

TABLE 6

| | | | Concentration of | Addition amount | | Addition | Concentration of | Addition amount |
|---|---|---|---|---|---|---|---|---|
| | | Addition | standard | of standard | | amount of | standard | of standard |
| | Concentration | amount of | solution of | solution of | Concentration | standard | solution of | solution of |
| Calibration | of standard | standard | internal standard | internal standard | of standard | solution of | internal standard | internal standard |
| curve | solution of | solution of | substance for | substance for | solution of | inactive | substance for | substance for |
| concentration | active GIP | active GIP | active GIP | active GIP | inactive GIP | GIP | inactive GIP | inactive GIP |
| (pM Plasma) | (pM) | (μL) | (pM) | (μL) | (pM) | (μL) | (pM) | (μL) |
| 1 | 20 | 10 | 1000 | 10 | — | — | — | — |
| 2 | 20 | 20 | 1000 | 10 | — | — | — | — |
| 5 | 20 | 50 | 1000 | 10 | — | — | — | — |
| 10 | 200 | 10 | 1000 | 10 | 200 | 10 | 10000 | 40 |
| 20 | 200 | 20 | 1000 | 10 | 200 | 20 | 10000 | 40 |
| 50 | 200 | 50 | 1000 | 10 | 200 | 50 | 10000 | 40 |
| 100 | 2000 | 10 | 1000 | 10 | 2000 | 10 | 10000 | 40 |
| 200 | 2000 | 20 | 1000 | 10 | 2000 | 20 | 10000 | 40 |
| 500 | 2000 | 50 | 1000 | 10 | 2000 | 50 | 10000 | 40 |

### 2. Pretreatment

The pretreatment was carried out according to the same method as in Example 8.

### 3. Measurement

The measurement was carried out in the same manner as in Example 8. The measuring conditions are shown in Table 7 and Table 8.

### (1) HPLC Conditions

TABLE 7

| | |
|---|---|
| LC system | Ultimate ™3000 nano-LC system |
| Trap column | C18, 5 μm, 100 Å, 300 μm i.d. × 1 mm |
| Mobile phase for trap column | 0.1% TFA-2% Acetonitrile |
| Flow rate | 25 μL/min |
| Analytical column | C18, 3 μm, 100 Å, 75 μm i.d. × 15 cm |
| Mobile phase A | 0.1% formic acid-2% methanol |
| Mobile phase B | 0.1% formic acid-95% methanol |
| Flow rate | 250 nL/min |

### (2) MS Conditions

TABLE 8

| | |
|---|---|
| Mass spectrometer | QTRAP ® 5500 |
| Ionization method | Nanospray ESI |
| Polarity | Positive |

Quantitative determination of active GIP

| | |
|---|---|
| Detection mode | MRM3 (Linear ion trap mode) |
| Monitor ion of substance to be | m/z 887.4 → m/z 782.4 → m/z 764.2 |
| measured | |
| Monitor ion of internal standard | m/z 897.4 → m/z 792.4 → m/z 774.2 |
| substance | |

Quantitative determination of non-active GIP

| | |
|---|---|
| Detection mode | MRM |
| Monitor ion of substance to be | m/z 653.2 → m/z 288.1, 435.3, 548.3 |
| measured | |
| Monitor ion of internal standard | m/z 663.2 → m/z 288.1, 445.2, 558.3 |
| substance | |

Results

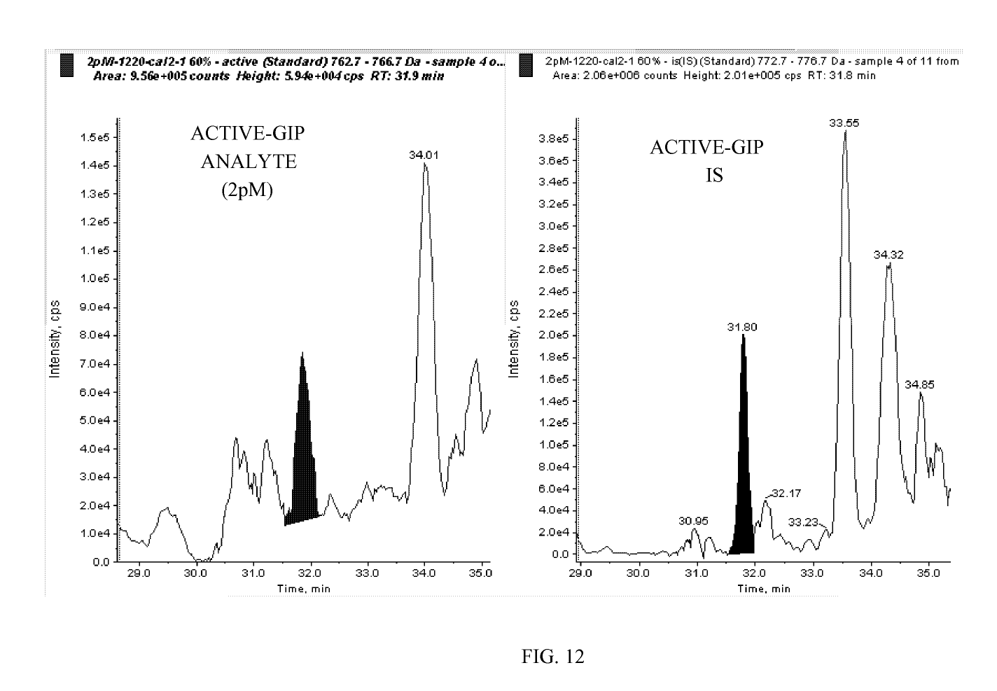

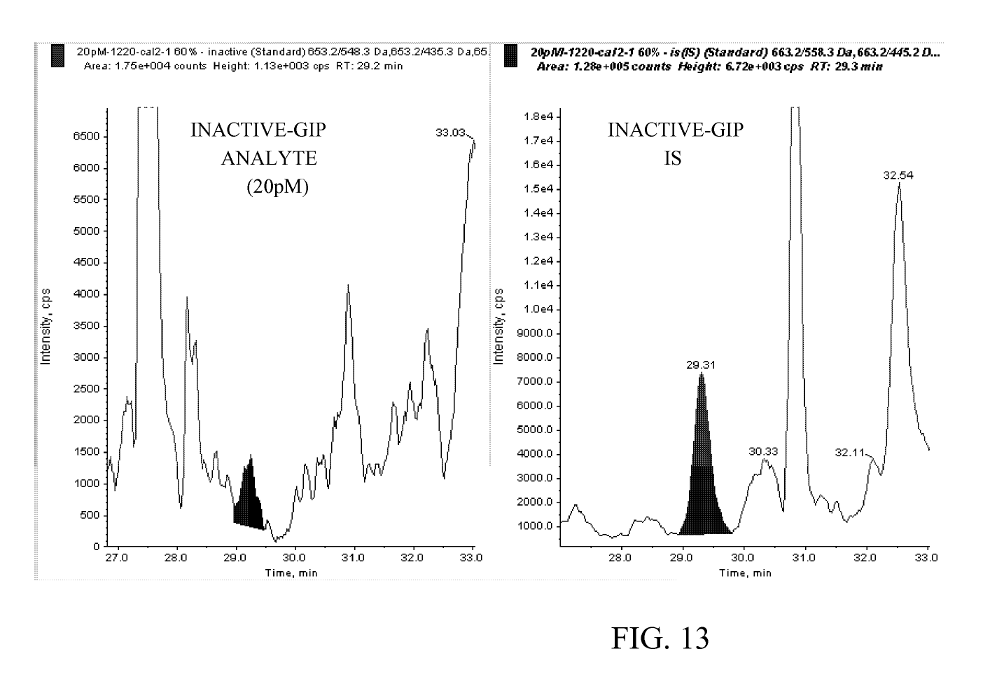

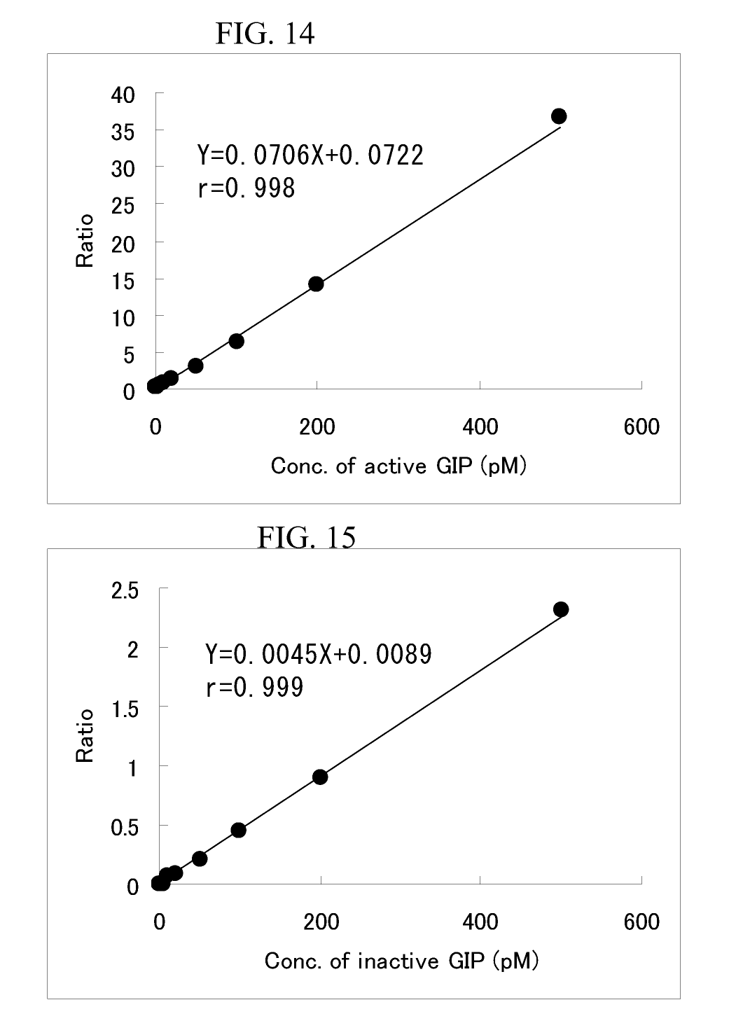

The calibration curve samples were measured, and the peptide fragment derived from the active GIP (Tyr-Ala-Glu-Gly-Thr-Phe-Ile-Ser [SEQ ID NO.: 1]) and the peptide fragment derived from the internal standard for the active GIP (Tyr-Ala-Glu-Gly-Thr-¹³C₉, ¹⁵N-Phe-Ile-Ser (the amino acid sequence is the same as SEQ ID NO.: 1)) each could be detected as an individual peak (FIG. 12). The peptide fragment derived from the inactive GIP (Glu-Gly-Thr-Phe-Ile-Ser [SEQ ID NO.: 3]) and the peptide fragment derived from the internal standard for the inactive GIP (Glu-Gly-Thr-¹³C₉, ¹⁵N-Phe-Ile-Ser (the amino acid sequence is the same as SEQ ID NO.: 3)) each could be detected as an individual peak (FIG. 13). The concentration of the active GIP and the peak area ratio of the two (the peak area of the peptide derived from the active GIP/the peak area of the peptide derived from the internal standard) were subjected to linear regression analysis using the linear least-squares method to calculate a slope, an intercept and a correlation coefficient (r). A calibration curve was made in the range of 1 pM to 500 pM. Consequently, the correlation coefficient (r) was 0.990 or more with 1/x weighting (FIG. 14). The concentration of the inactive GIP and the peak area ratio of the two (the peak area of the peptide derived from inactive GIP/the peak area of the peptide derived from the internal standard for inactive GIP) were subjected to linear regression analysis using the linear least-squares method to calculate a slope, an intercept and a correlation coefficient (r). A calibration curve was made in the range of 10 pM to 500 pM. Consequently, the correlation coefficient (r) was 0.990 or more with 1/x weighting (FIG. 15).

### Example 11

### Simultaneous Quantitative Determination of Active GIP and Inactive GIP in Diabetic Patients

In 6 diabetic patients taking α-glucosidase inhibitors (50 mg, three times a day), active GIP [SEQ ID NO.: 13] and inactive GIP [SEQ ID NO.: 14] in plasma were simultaneously quantitated before eating and at one hour after eating.

### 1. Preparation of Samples

### (1) Preparation of Calibration Curve Samples

Samples were prepared as shown in Table 9 in the same manner as in Example 9.

TABLE 9

| | | | Concentration of | Addition amount | | Addition | Concentration of | Addition amount |
|---|---|---|---|---|---|---|---|---|
| | | Addition | standard | of standard | | amount of | standard | of standard |
| | Concentration | amount of | solution of | solution of | Concentration | standard | solution of | solution of |
| Calibration | of standard | standard | internal standard | internal standard | of standard | solution of | internal standard | internal standard |
| curve | solution of | solution of | substance for | substance for | solution of | inactive | substance for | substance for |
| concentration | active GIP | active GIP | active GIP | active GIP | inactive GIP | GIP | inactive GIP | inactive GIP |
| (pM Plasma) | (pM) | (μL) | (pM) | (μL) | (pM) | (μL) | (pM) | (μL) |
| 1 | 20 | 10 | 1000 | 20 | — | — | — | — |
| 2 | 20 | 20 | 1000 | 20 | — | — | — | — |
| 5 | 20 | 50 | 1000 | 20 | — | — | — | — |
| 10 | 200 | 10 | 1000 | 20 | 200 | 10 | 10000 | 20 |
| 20 | 200 | 20 | 1000 | 20 | 200 | 20 | 10000 | 20 |
| 50 | 200 | 50 | 1000 | 20 | 200 | 50 | 10000 | 20 |
| 100 | 2000 | 10 | 1000 | 20 | 2000 | 10 | 10000 | 20 |
| 200 | 2000 | 20 | 1000 | 20 | 2000 | 20 | 10000 | 20 |
| 500 | 2000 | 50 | 1000 | 20 | 2000 | 50 | 10000 | 20 |

(2) Preparation of Plasma Samples from Diabetic Patients

Blood was collected from a patient taking an α-glucosidase inhibitor using a blood collection tube with a protein stabilizer (manufactured by Becton, Dickinson and Company) to obtain plasma. To 200 μL of this plasma, an internal standard for the active GIP and an internal standard for the inactive GIP were added in amounts equal to those when making the above-mentioned calibration curve.

### 2. Measurement

A sample subjected to pretreatment was measured in the same manner as in Example 8. The measuring conditions are shown in Table 10 and Table 12.

TABLE 10

| | |
|---|---|
| LC system | Ultimate ™3000 nano-LC system |
| Trap column | C18, 5 μm, 100 Å, 300 μm i.d. × 1 mm |
| Mobile phase for trap column | 0.1% TFA-2% Acetonitrile |
| Flow rate | 25 μL/min |
| Analytical column | C18, 3 μm, 100 Å, 75 μm i.d. × 15 cm |
| Mobile phase A | 0.1% formic acid-2% methanol |
| Mobile phase B | 0.1% formic acid-95% methanol |
| Flow rate | 250 nL/min |

TABLE 11
Gradient conditions

| Time (min) | Mobile phase A (%) | Mobile phase B (%) |
|---|---|---|
| 0 | 100 | 0 |
| 2 | 100 | 0 |
| 3 | 75 | 25 |
| 21.2 | 40 | 60 |
| 22 | 0 | 100 |
| 27 | 0 | 100 |
| 27.1 | 100 | 0 |
| 35 | 100 | 0 |

TABLE 12

| | |
|---|---|
| Mass spectrometer | QTRAP ® 5500 |
| Ionization method | Nanospray ESI |
| Polarity | Positive |

Quantitative determination of active GIP

| | |
|---|---|
| Detection mode | MRM3 (Linear ion trap mode) |
| Monitor ion of substance to be | m/z 887.4 → m/z 782.4 → m/z 764.2 |
| measured | |
| Monitor ion of internal standard | m/z 897.4 → m/z 792.4 → m/z 774.2 |
| substance | |
| Curtain Gas Setting (Nitrogen) | 10 psi |
| Collision Gas Setting (Nitrogen) | High |
| Gas 1 Setting (Zero Air) | 5.0 psi |
| Gas 2 Setting (Zero Air) | 0.0 psi |
| AF2 Setting | 0.12 |
| Interface Heater Temperature | 150° C. |

Quantitative determination of inactive GIP

| | |
|---|---|
| Detection mode | MRM |
| Monitor ion of substance to be | m/z 653.2 → m/z 288.1, 435.3, 548.3 |
| measured | |
| Monitor ion of internal standard | m/z 663.2 → m/z 288.1, 445.2, 558.3 |
| substance | |
| Curtain Gas Setting (Nitrogen) | 10 psi |
| Collision Gas Setting (Nitrogen) | 12.0 |
| Gas 1 Setting (Zero Air) | 5.0 psi |
| Gas 2 Setting (Zero Air) | 0.0 psi |

Results

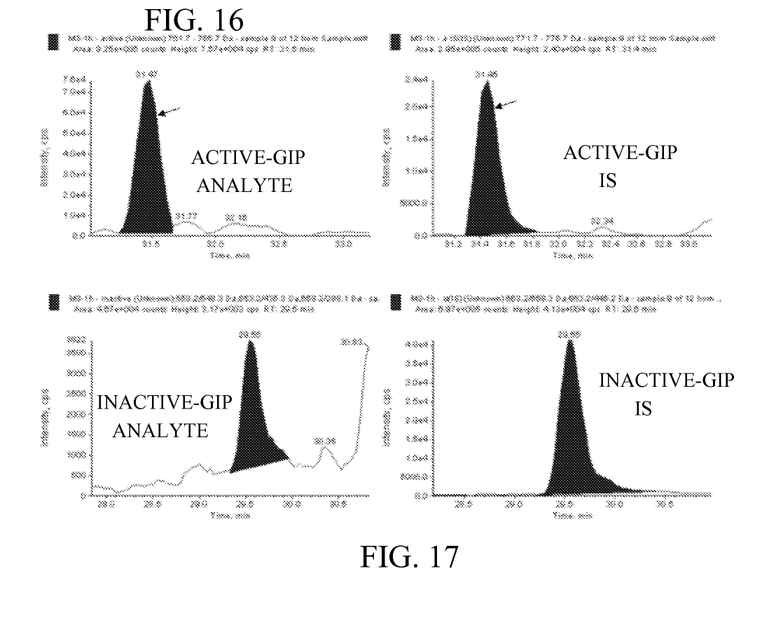

The plasma samples from the diabetic patients were measured, and the peptide fragment derived from the active GIP [SEQ ID NO.: 1] and the peptide fragment derived from the internal standard for the active GIP (the amino acid sequence is the same as SEQ ID NO.: 1) each could be detected as an individual peak (FIG. 16). Similarly, the inactive GIPs each could be also detected as an individual peak (FIG. 17). The concentration of the active GIP and the peak area ratio of the two (the peak area of the peptide derived from the active GIP/the peak area of the peptide derived from the internal standard) were subjected to linear regression analysis using the linear least-squares method to make a calibration curve with 1/x weighting in a range of 1 pM to 500 pM. The peak area ratio (the peak area of the peptide derived from the active GIP/the peak area of the peptide derived from the internal standard) obtained from a plasma sample from a diabetic patient was fitted to the calibration curve to calculate the concentration of the active GIP in the plasma. For the inactive GIP, a calibration curve was made with 1/x weighting in the range of 10 pM to 500 pM in the same manner as for the active GIP to calculate the concentration of the inactive GIP in the plasma of diabetic patients. The results are shown in Table 13. The numerical values in the table show each average concentration in plasma±standard deviation.

TABLE 13

| | Active GIP (pM) | Inactive GIP (pM) |
|---|---|---|
| Before eating | 19.2 ± 8.9 | 58.4 ± 33.2 |
| One hour after | 76.3 ± 53.5 | 176 ± 28 |
| eating | | |

For glucagon-secretin family peptides other than GIP, calibration curves are made in the same manner as in Examples 8 to 11, and glucagon-secretin family peptides in a sample can be quantitated using the calibration curves. That is, a peptide to be quantitated is extracted together with an internal standard in which e.g. a portion of an amino acid thereof is substituted with a stable isotope label; in the extraction process as shown in Examples 1 to 7, the peptide bond of any aspartic acid selected from positions 1-14 of glucagon-secretin family peptides is cleaved to obtain peptide fragments. Similarly to GIP, quantitative determination with high specificity can be carried out by setting the mass spectrometry conditions in accordance with the peptide fragments. Further, as active GIP and inactive GIP can be simultaneously quantitated when the extraction conditions are same, different glucagon-secretin family peptides can be simultaneously quantitated.

1. A method for analyzing a glucagon-secretin family peptide in a sample, the method comprising:
cleaving a peptide bond of at least one aspartic acid within the glucagon-secretin family peptide to generate a plurality of peptide fragments, wherein at least one of the peptide fragments contains an N-terminal end of the glucagon-secretin family peptide;
separating and purifying the plurality of peptide fragments using liquid chromatography to select the peptide fragment that contains the N-terminal end of the glucagon-secretin family peptide; and
carrying out mass spectrometry on the sample to detect the peptide fragment that contains the N-terminal end of the glucagon-secretin family peptide.

2. The method according to claim 1, wherein in the cleavage step the peptide bond of the at least one aspartic acid is cleaved using a cleaving agent selected from the group consisting of a site-specific protease and an acid.

3. The method according to claim 2, wherein the cleaving agent is selected from the group consisting of endopeptidase ASP-N, formic acid, acetic acid, trifluoroacetic acid, propionic acid and combinations thereof.

4. The method according to claim 1, wherein the liquid chromatography is performed at a flow rate of 50 nL/min to 50 μL/min.

5. The method according to claim 1, wherein the glucagon-secretin family peptide is selected from the group consisting of glucose-dependent insulinotropic polypeptide, glucagon-like peptide-1, glucagon-like peptide-2, glucagon and analogs thereof.

6. The method according to claim 1, wherein the peptide fragment that contains the N-terminal end of the glucagon-secretin family peptide is selected in the separation/purification step by mass selection of a precursor ion.

7. The method according to claim 1, wherein the separation/purification step further comprises solid-phase extraction of the peptide fragment that contains the N-terminal end of the glucagon-secretin family peptide.

8. The method according to claim 1, wherein the separation/purification step and the analysis step are carried out using high performance liquid chromatography/mass spectrometry/mass spectrometry/mass spectrometry.

9. A method for quantitating a glucagon-secretin family peptide in a sample, comprising:
generating a calibration curve using the analysis method according to claim 1 and
quantitating the glucagon-secretin family peptide in the sample using the calibration curve.

10. The method according to claim 9, wherein the sample contains two or more glucagon-secretin family peptides that are distinguished and simultaneously quantitated by simultaneously measuring the peptide fragment that contains the N-terminal end of each of the two or more glucagon-secretin family peptides.

11. The method according to claim 9, wherein the sample contains biologically-active and biologically-inactive glucagon-secretin family peptides that are distinguished and simultaneously quantitated by simultaneously measuring peptide fragment that contains the N-terminal end of each of the biologically-active glucagon-secretin family peptide and the biologically-inactive glucagon-secretin family peptide.

12. The method according to claim 9, wherein the step of generating the calibration curve further comprises adding a stable isotope-labeled internal standard to the sample.

13. The method according to claim 12, wherein the quantitative determination is carried out using a peak area ratio of each of the peptide fragment that contains the N-terminal end and the internal standard peptide fragment.

14. The method according to claim 12, wherein the internal standard is a peptide in which one or more amino acids selected from positions 1-15 of the glucagon-secretin family peptide are substituted with (a) stable isotope-labeled amino acid(s).

15. A kit for quantitating a glucagon-secretin family peptide, the kit comprising:
(a) a matrix for control,
(b) at least one internal standard or solution thereof,
(c) at least one glucagon-secretin family peptide or standard thereof, or solution thereof,
(d) a cleaving agent, and
(e) a solid phase extraction plate.

16. The kit according to claim 15, wherein the cleaving agent is selected from the group consisting of endopeptidase ASP-N, formic acid, acetic acid, trifluoroacetic acid, propionic acid and combinations thereof.

17. The kit according to claim 15, wherein the glucagon-secretin family peptide is selected from the group consisting of glucose-dependent insulinotropic polypeptide, glucagon-like peptide-1, glucagon-like peptide-2, glucagon and analogs thereof.

18. A method for detecting a glucagon-secretin family peptide in a sample, the method comprising:
contacting the sample with a cleaving agent capable of digesting the glucagon-secretin family peptide by cleaving a peptide bond of at least one aspartic acid within the glucagon-secretin family peptide and thereby generating a plurality of peptide fragments, wherein at least one of the peptide fragments contains an N-terminal end of the glucagon-secretin family peptide; and
detecting the peptide fragment that contains the N-terminal end of the glucagon-secretin family peptide using liquid chromatography and mass spectrometry.

19. The method according to claim 18, wherein:
the cleaving agent is selected from the group consisting of endopeptidase ASP-N, formic acid, acetic acid, trifluoroacetic acid, propionic acid and combinations thereof;
the liquid chromatography is performed at a flow rate of 50 nL/min to 50 μL/min;
the glucagon-secretin family peptide is selected from the group consisting of glucose-dependent insulinotropic polypeptide, glucagon-like peptide-1, glucagon-like peptide-2, glucagon and analogs thereof; and
the detection is carried out using high performance liquid chromatography/mass spectrometry/mass spectrometry/mass spectrometry.

20. The method according to claim 19, wherein the detection of the peptide fragment that contains the N-terminal end of the glucagon-secretin family peptide includes selecting a mass of a precursor ion in the mass spectrometry and
the method further comprises, prior to the detection step, solid-phase extraction of the peptide fragment that contains the N-terminal end of the glucagon-secretin family peptide.
